(19) United States
(12) Patent Application Publication
(10) Pub. No.: US 2016/0117299 A1
(43) Pub. Date: Apr. 28, 2016

(54) DEVICE, METHOD, AND GRAPHICAL USER INTERFACE FOR VISIBLE AND INTERACTIVE CORRECTED CONTENT

(71) Applicant: Apple Inc., Cupertino, CA (US)

(72) Inventor: Christopher J. Hynes, Mountain View, CA (US)

(21) Appl. No.: 14/815,910

(22) Filed: Jul. 31, 2015

Related U.S. Application Data
(60) Provisional application No. 62/068,429, filed on Oct. 24, 2014.

(51) Int. Cl. G06F 17/24; H04L 12/58

(52) U.S. Cl. CPC G06F 17/24; H04L 51/063

(57) ABSTRACT

An entered character string, which is part of a draft electronic message, is received. The draft electronic message is modified by replacing the entered character string with a replacement character string. The modified electronic message is sent, and a transcript comprising the modified electronic message is displayed. The replacement character string is visually distinguished within the transcript from one or more other character strings in the transcript.

### CROSS-REFERENCE TO RELATED APPLICATION

This application claims the benefit of U.S. Provisional Patent Application No. 62/068,429, filed Oct. 24, 2014, which is incorporated herein by reference in its entirety.

### TECHNICAL FIELD

This relates generally to user interfaces, and in particular to user interfaces for displaying and enabling interaction with corrected content in electronic messages.

### BACKGROUND

Electronic messages, including text messages, instant messages, and email, provide a convenient mechanism for people to communicate with one another. Electronic devices generate electronic messages using character strings entered by a user and send the electronic messages to one or more recipients. To enhance the convenience of electronic messages, some electronic devices replace character strings entered by a user with replacement character strings. When the electronic message is sent to a recipient, the electronic device sends the electronic message with the replacement character string replacing the entered character string.

### SUMMARY

However, if the replacement character string is not the string intended by the sender of the message, a recipient of the message may be confused by the message. Furthermore, if the sender of the message does not realize that the sent message included an unintended character string, the sender may not know to clarify the message. To address this confusion, the recipient and the sender exchange additional messages, which is tedious, creates cognitive burdens, and takes longer than necessary (thereby wasting energy).

Accordingly, an improved user interface for displaying electronic messages including replacement character strings is needed. Devices, methods, and graphical user interfaces for sending and receiving electronic messages including replacement character strings improve communication between a sender and recipient by informing the sender and/or the recipient when a character string was replaced by an electronic device. Such devices, methods, and interfaces reduce the cognitive burden on users and produce a more efficient human-machine interface.

In accordance with some embodiments, a method is performed by an electronic device for sending an electronic message including a replacement character string. The method comprises receiving an entered character string, wherein the entered character string is part of a draft electronic message. The method also includes modifying the draft electronic message by replacing the entered character string with a replacement character string and sending the modified electronic message. The method further includes displaying a transcript comprising the modified electronic message, wherein the replacement character string is visually distinguished within the transcript from one or more other character strings in the transcript.

In accordance with some embodiments, a method is performed by an electronic device for receiving an electronic message including a replacement character string. The method comprises receiving an electronic message, wherein the electronic message includes a replacement character string that replaced an entered character string prior to the electronic message being sent. The method also includes displaying the electronic message, wherein the replacement character string is visually distinguished within the displayed electronic message from one or more other character strings in the electronic message.

Thus, devices, user interfaces, and methods for sending and receiving electronic messages as described herein notify senders and recipients when an electronic message includes a replacement character string by visually distinguishing the replacement character string from one or more other strings.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5B illustrate exemplary user interfaces for composing and viewing sent electronic messages in accordance with some embodiments.

FIGS. 6A-6C illustrate exemplary user interfaces visually distinguishing replacement character strings from other strings in an electronic message in accordance with some embodiments.

FIG. 7A illustrates an exemplary user input corresponding to a location of a replacement character string in accordance with some embodiments.

FIGS. 7B-7D illustrate exemplary entered character strings displayed in response to a user input corresponding to a location of a replacement character string in accordance with some embodiments.

FIGS. 8A-8C illustrate exemplary user inputs to send corrective or clarifying electronic messages in accordance with some embodiments.

FIG. 8D illustrates an exemplary corrective electronic message in accordance with some embodiments.

FIG. 8E illustrates an exemplary clarification message in accordance with some embodiments.

FIG. 9A illustrates exemplary replacement character strings visually distinguished from other character strings in a draft electronic message in accordance with some embodiments.

FIGS. 9B-9C illustrate exemplary replacement character strings visually distinguished from other character strings in a draft electronic message in response to detecting a precursor to an input to send the message in accordance with some embodiments.

FIGS. 9D-9E illustrate an exemplary user input to cancel sending a message in accordance with some embodiments.

FIGS. 10A-10D illustrate exemplary user inputs to turn off visual distinctions of replacement character strings in accordance with some embodiments.

FIG. 11 illustrates an exemplary message transcript including multiple electronic messages in accordance with some embodiments.

FIG. 12 illustrates an exemplary user interface for viewing received electronic messages in accordance with some embodiments.

FIGS. 13A-13B illustrate an exemplary clarification request in accordance with some embodiments.

FIG. 14A illustrates an exemplary user input corresponding to a location of a replacement character string in accordance with some embodiments.

FIGS. 14B-14D illustrate exemplary entered character strings and candidate replacement character strings displayed in response to a user input corresponding to a location of a replacement character string in accordance with some embodiments.

FIGS. 15A-15D illustrate exemplary user inputs to turn off visual distinction of replacement character strings in accordance with some embodiments.

FIG. 16 illustrates an exemplary message transcript including multiple electronic messages in accordance with some embodiments.

FIGS. 17A-17C illustrate exemplary user interfaces for composing electronic messages in accordance with some embodiments.

FIG. 18 is a flowchart illustrating an exemplary method for sending electronic messages including replacement character strings in accordance with some embodiments.

FIGS. 19-20 are functional block diagrams of electronic devices in accordance with some embodiments.

### DETAILED DESCRIPTION

An electronic device displays a user interface for a user to compose and view electronic messages. In some embodiments, the user interface provides a text input area adapted to receive character strings from a user to compose an electronic message. The user interface may also include a transcript displaying one or more electronic messages sent or received by the user of the electronic device.

In some embodiments, the electronic device visually distinguishes one or more replacement character strings from character strings entered by the user when displaying an electronic message sent by the user in the message user interface. The user interface is interactive in some embodiments, enabling a user to view the entered character string or send messages clarifying a replacement character string in an earlier message. Similarly, the electronic device may visually distinguish the replacement character strings from entered character strings in an electronic message received by a user. The user interface displayed to the recipient may also display entered character strings or candidate replacement character strings to the recipient in response to user inputs received at the interface, or the electronic device used by the recipient may send messages to the sender to request clarification of a replacement character string.

Accordingly, embodiments of user interfaces described herein improve user experiences with electronic messages. By visually distinguishing replacement character strings in electronic messages, senders and recipients of the messages are notified when an electronic message includes a replacement character string.

### Exemplary Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

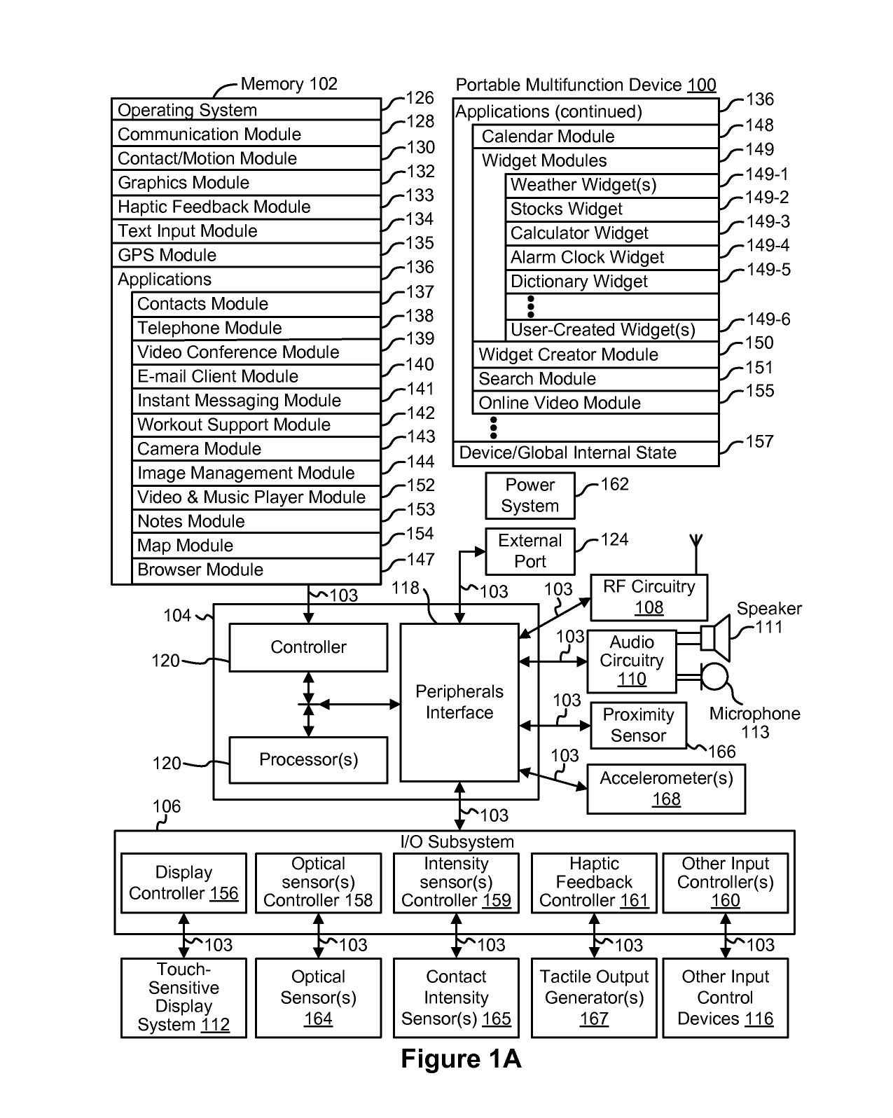

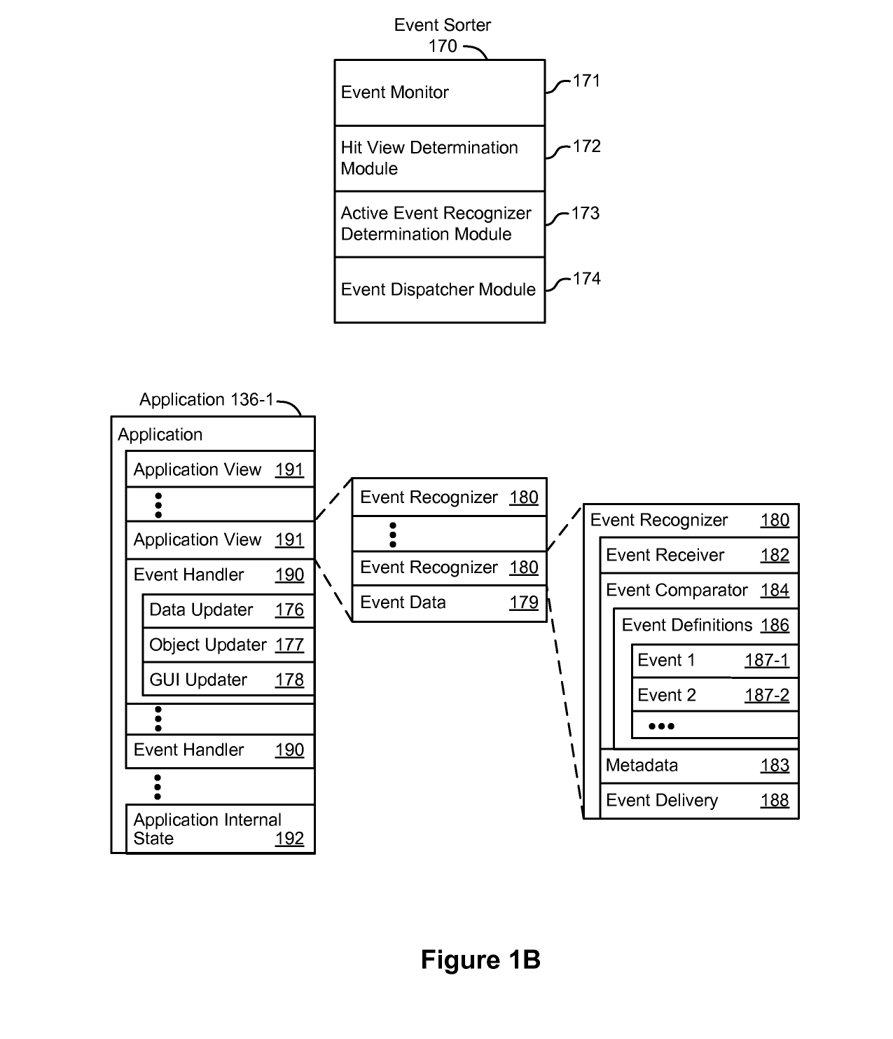

Attention is now directed toward embodiments of portable devices with touch-sensitive displays. FIG. 1A is a block diagram illustrating portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch sensitive surface, or to a substitute (proxy) for the force or pressure of a contact on the touch sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU 120 and the peripherals interface 118, is, optionally, controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n),

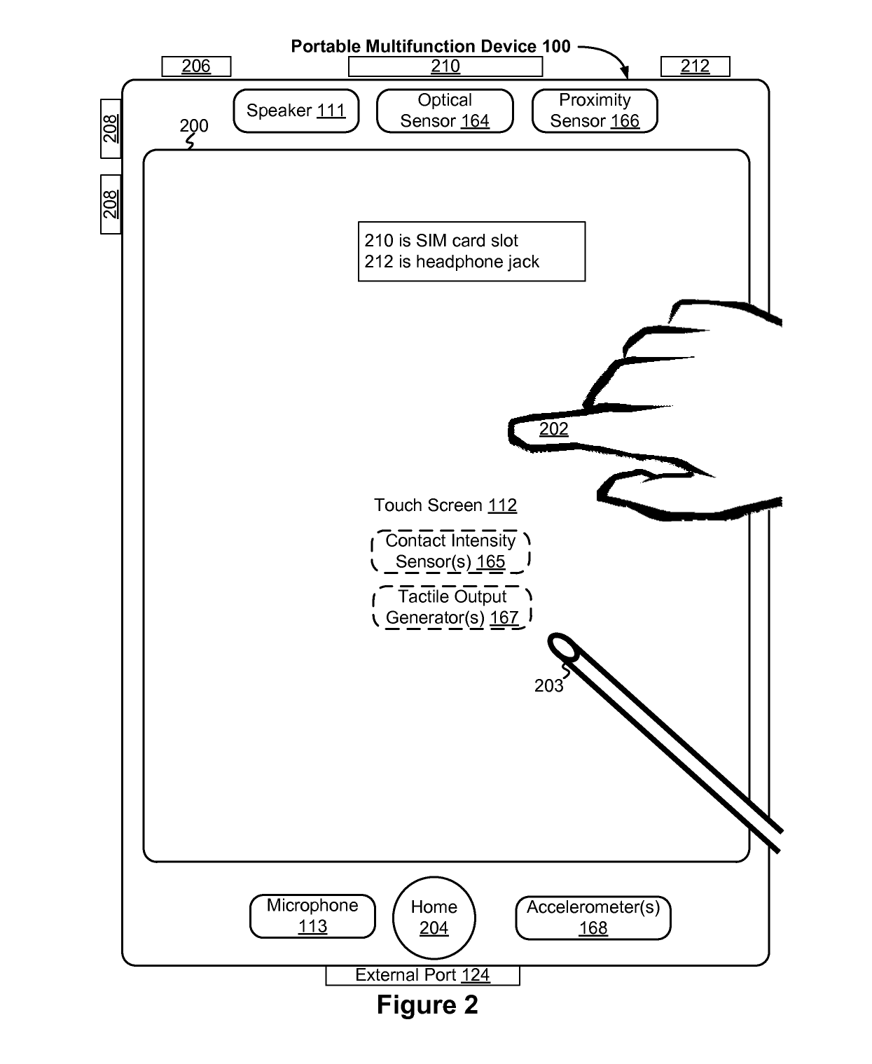

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, Calif.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device, so that the touch screen display is enabled for use as a viewfinder for still and/or video image acquisition. In some embodiments, another optical sensor is located on the front of the device so that the user's image is, optionally, obtained for videoconferencing while the user views the other video conference participants on the touch screen display.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is coupled to input controller 160 in I/O subsystem 106. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in Figures IA and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined thresholds values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 are, optionally, used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 are, optionally, used by a user to create widgets (e.g., turning a user-specified portion of a web page into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact module 130, graphics module 132, and text input module 134, notes module 153 includes executable instructions to create and manage notes, to do lists, and the like in accordance with user instructions.

In conjunction with RF circuitry 108, touch screen 112, display system controller 156, contact module 130, graphics module 132, text input module 134, GPS module 135, and browser module 147, map module 154 are, optionally, used to receive, display, modify, and store maps and data associated with maps (e.g., driving directions; data on stores and other points of interest at or near a particular location; and other location-based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

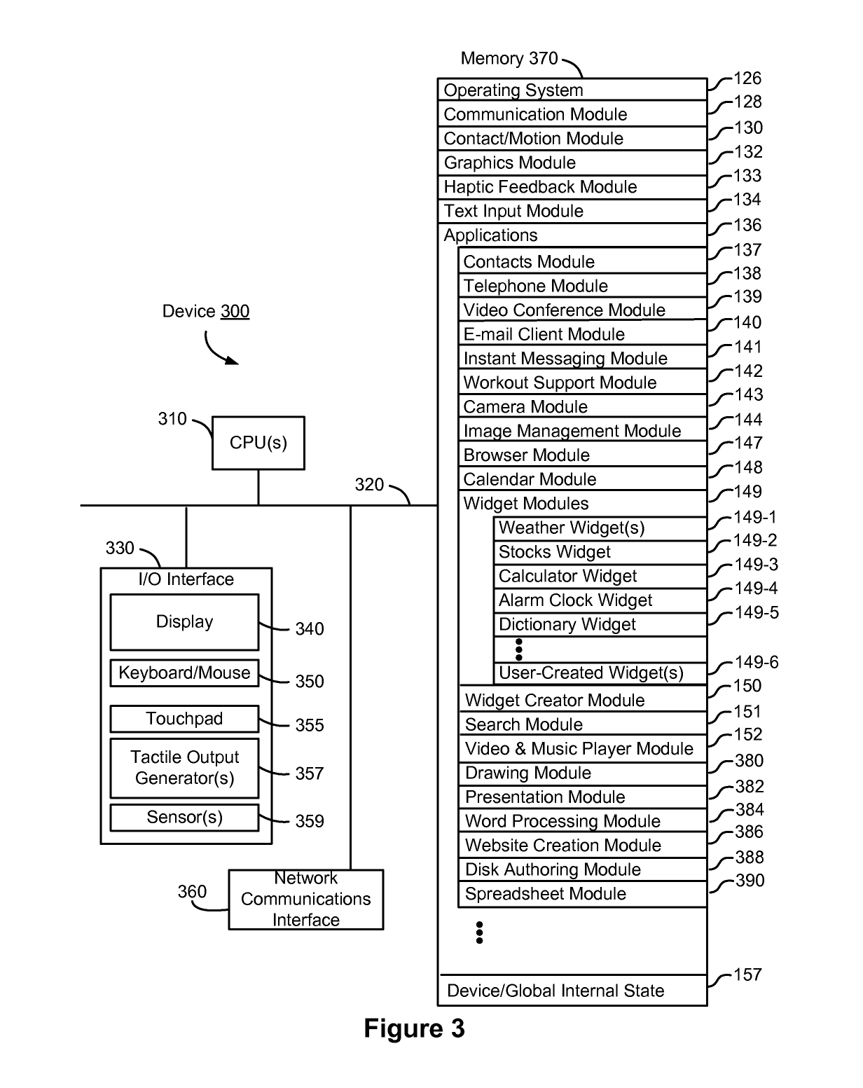

FIG. 1B is a block diagram illustrating exemplary components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 137-13, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that is, optionally, implemented on portable multifunction device 100.

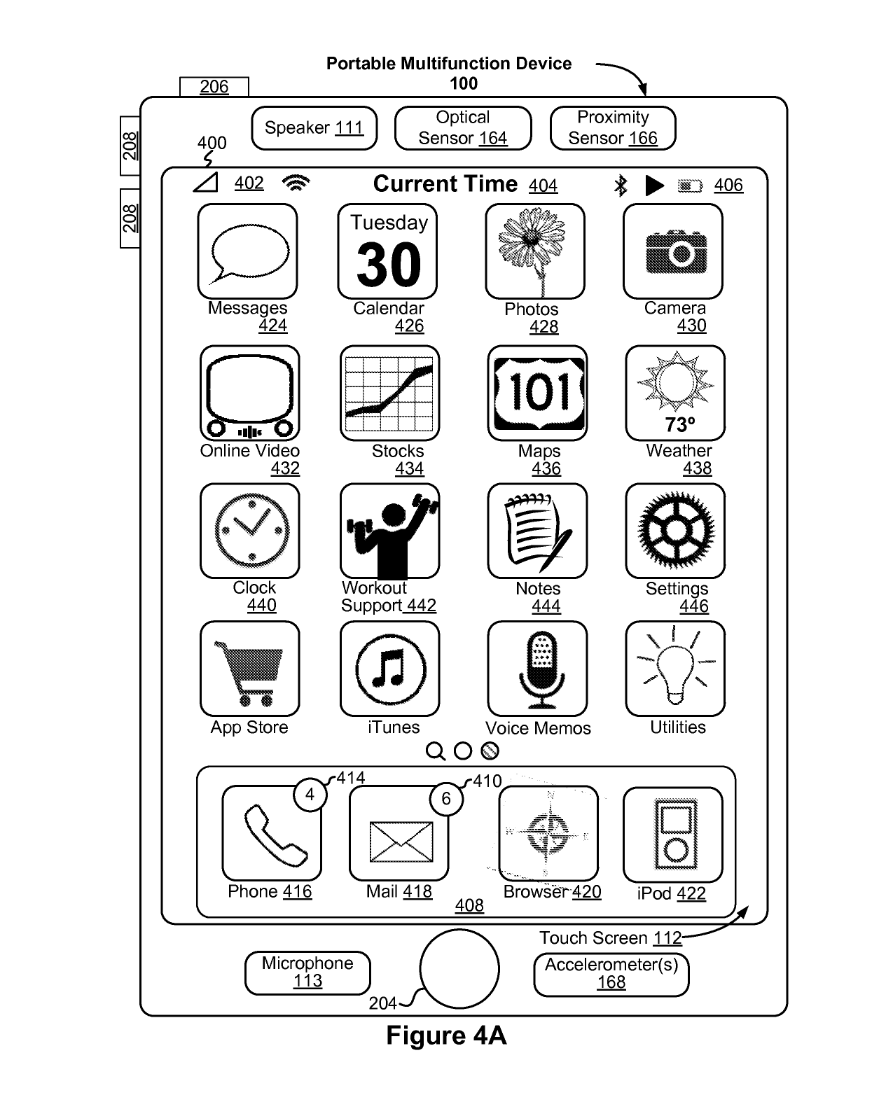

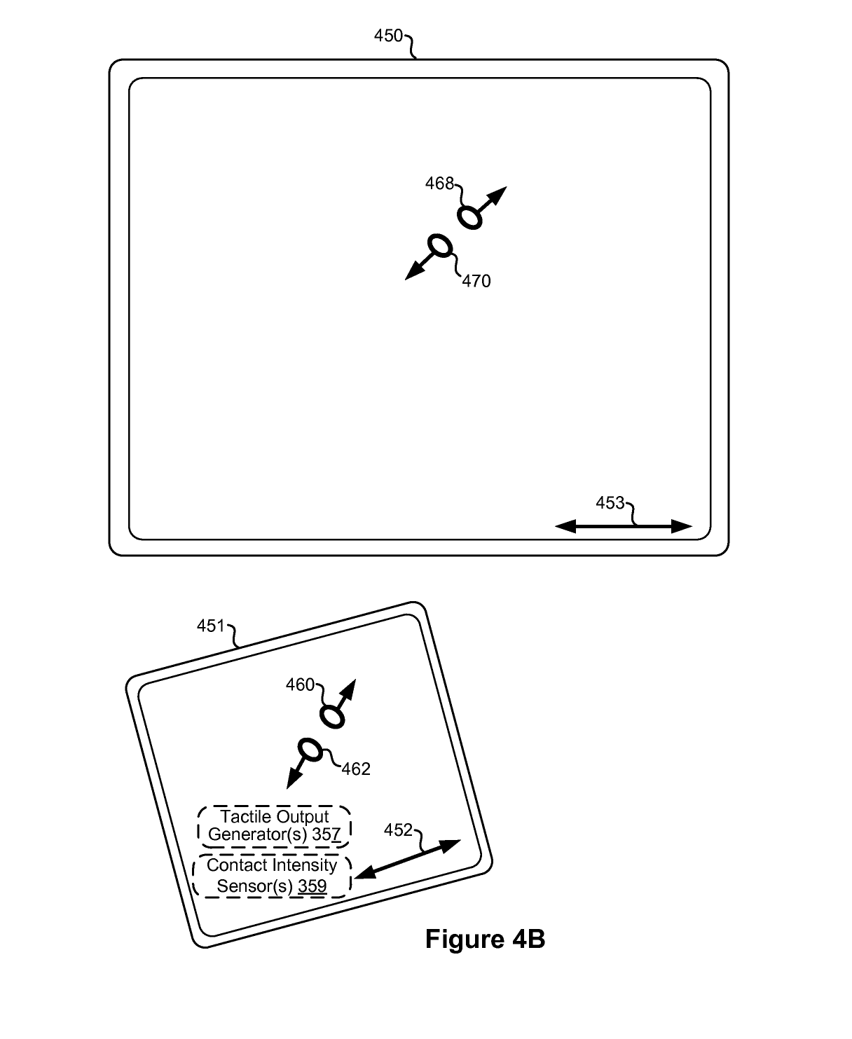

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Text;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video”
   Icon 434 for stocks widget 149-2, labeled “Stocks;”
   Icon 436 for map module 154, labeled “Map;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, which provides access to settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 357) for detecting intensity of contacts on touch-sensitive surface 451 and/or one or more tactile output generators 359 for generating tactile outputs for a user of device 300.

Although some of the examples which follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments the touch sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch- sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch- sensitive surface (e.g., 451 in FIG. 4B) are used by the device to manipulate the user interface on the display (e.g., 450 in FIG. 4B) of the multifunction device when the touch- sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or touch screen 112 in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device with a display and an input device, such as a touch-sensitive surface or a mouse and keyboard. For example, embodiments of user interfaces and associated processes are implemented on device 300 or portable multifunction device 100.

### Sender-Side User Interfaces

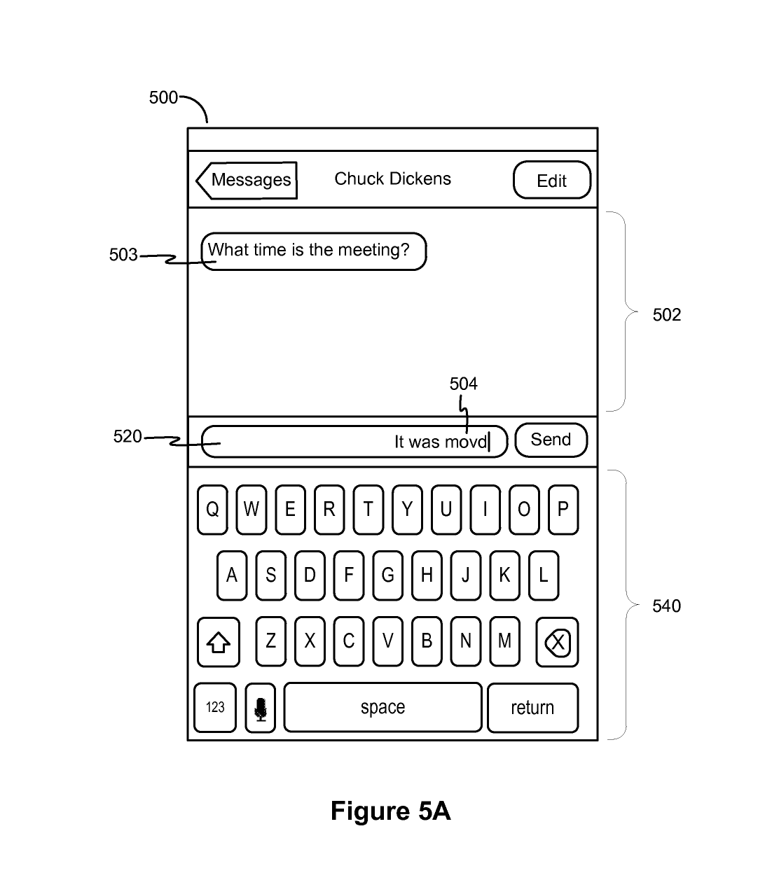

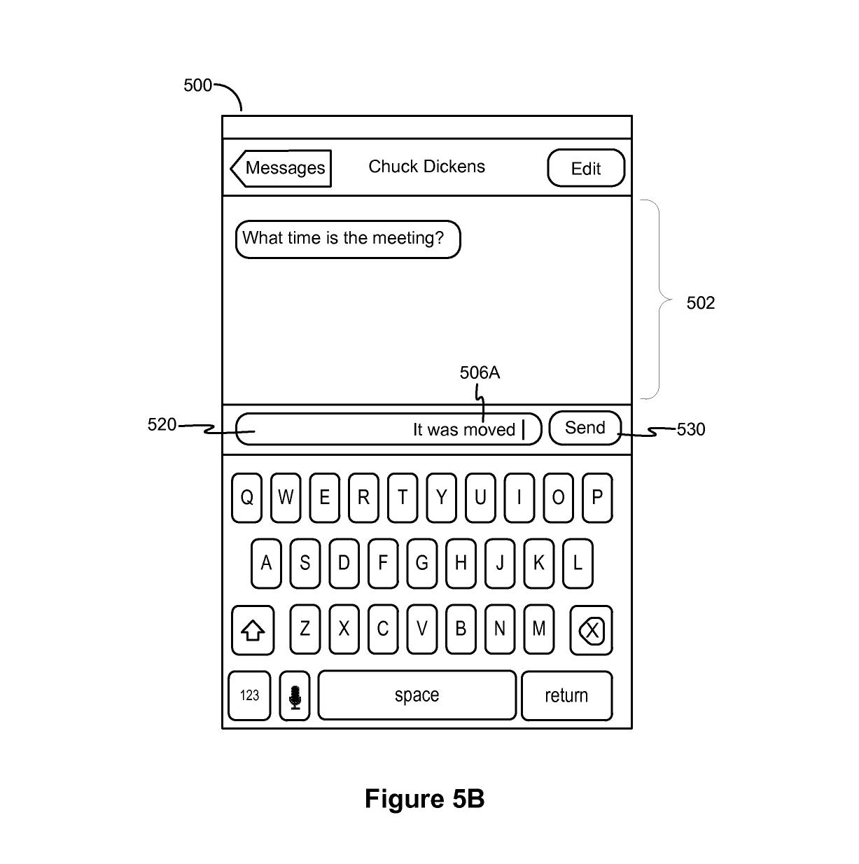

FIG. 5A illustrates an example user interface 500 for composing and viewing electronic messages. The user interface 500 is displayed by an electronic device, such as device 300 or portable multifunction device 100. The user interface 500 includes various input and display elements adapted to display electronic messages sent by or received by a user. The user interface 500 may display any of a variety of types of electronic messages, including, for example, instant messages, short message service (SMS) messages, or emails. In some embodiments, as shown in FIG. 5A, the user interface 500 includes a transcript 502 and a text entry box 520. Some embodiments of the user interface 500 include additional components not shown in FIG. 5A.

The transcript 502 displays one or more messages sent by the user or received by the user. For example, the message 503 displayed in the transcript 502 is an electronic message sent by another user to the user of electronic device displaying the user interface 500. In some embodiments, the transcript 502 displays a set of messages in a conversation between two or more users. For example, the transcript 502 displayed to a first user includes electronic messages sent by the first user to a second user and electronic messages sent by the second user to the first user. As another example, the transcript 502 displayed to a first user includes electronic messages sent by the first user to two or more other users and messages sent by the other users to the first user. In some embodiments, the transcript 502 is scrollable or expandable to reveal additional messages in a conversation.

In some embodiments, the user interface 500 also displays portions of draft electronic messages. The text entry box 520 displays a draft electronic message as a user composes the message. As the electronic device receives character strings of an electronic message, the device displays the text strings in the text entry box 520. In some embodiments, the text entry box 520 and transcript 502 are displayed in separate interfaces. Alternatively, the text entry box 520 is, optionally, displayed in response to a user command to start composing a new electronic message.

In some embodiments, the user interface 500 further comprises a keyboard 540. In these embodiments, the electronic device displays the keyboard 540 and receives character strings based on user inputs received at the locations of the keys in the displayed keyboard 540. In some embodiments, the electronic device receives character strings from other input devices, such as a physical keyboard in communication with the electronic device.

In FIG. 5A, the text entry box 520 displays an example portion of an electronic message being composed by a user. The user has entered two complete character strings, which are separated by a space, and has started entering a third character string 504. When the user enters a space after the character string 504 to indicate the character string 504 is complete, the electronic device replaces the entered character string 504 with a replacement character string 506A, shown in FIG. 5B. In this example, the electronic device replaces the misspelled word “movd” entered by the user with a corrected spelling “moved.” In some embodiments, the electronic device replaces the entered character string 504 automatically, without explicit user input to replace the character string. For example, the electronic device modifies the draft message based on autocorrection criteria, replacing a character string entered by the user with a replacement character string automatically selected by the electronic device. In some embodiments, if the user disagrees with the replacement character string automatically selected by the electronic device, then the user enters a different character string to replace the automatically-selected replacement character string. The different entered character string may subsequently be replaced by a second automatically-selected replacement character string. In some embodiments, the electronic device suggests one or more alternative character strings to the user. If the user selects or confirms one of the alternative character strings as a replacement of the entered character string 504, the electronic device replaces the entered character string 504 with the selected or confirmed alternative string. In some embodiments, the user confirms an alternative character string by activating the spacebar while the alternative character string is displayed. By replacing the entered character string 504 with the replacement character string 506A, the electronic device modifies the draft electronic message displayed in the text entry box 520.

The user may enter additional character strings after the replacement character string 506A to continue composing the electronic message. As the user enters additional character strings, the electronic device may replace additional character strings in the electronic message with replacement character strings. When the message is complete, the user may interact with a portion of the user interface 500 (e.g., providing an input that corresponds to the location of the send button 530) to send the electronic message to a recipient. In response to the user input, the electronic device sends the electronic message to the recipient with the replacement string 506A replacing the entered character string 504. In some embodiments, the electronic device sends the electronic message with replacement information including the entered character string 504 (and possibly additional entered character strings) or candidate replacement character strings that were considered and an indication that the replacement character string 506A replaced the entered character string 504 (or replaced one of the possible additional entered character strings).

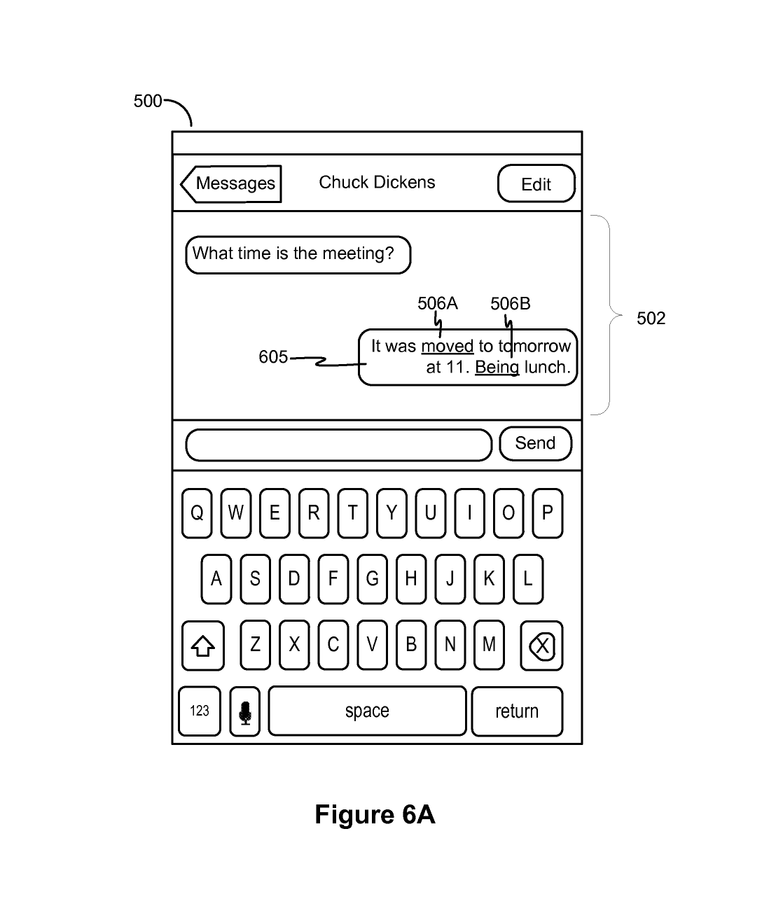

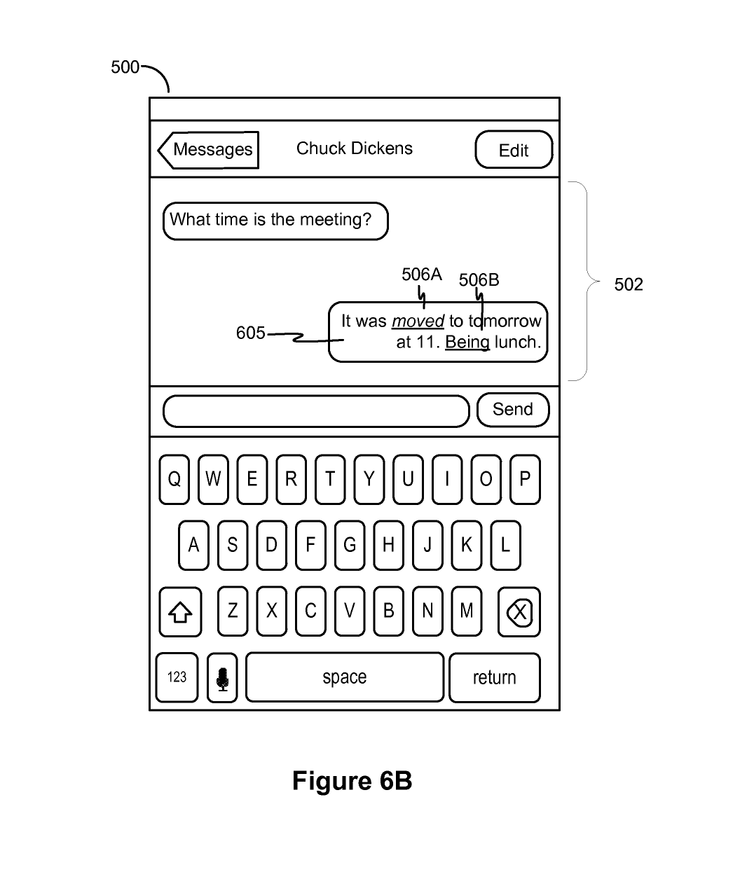

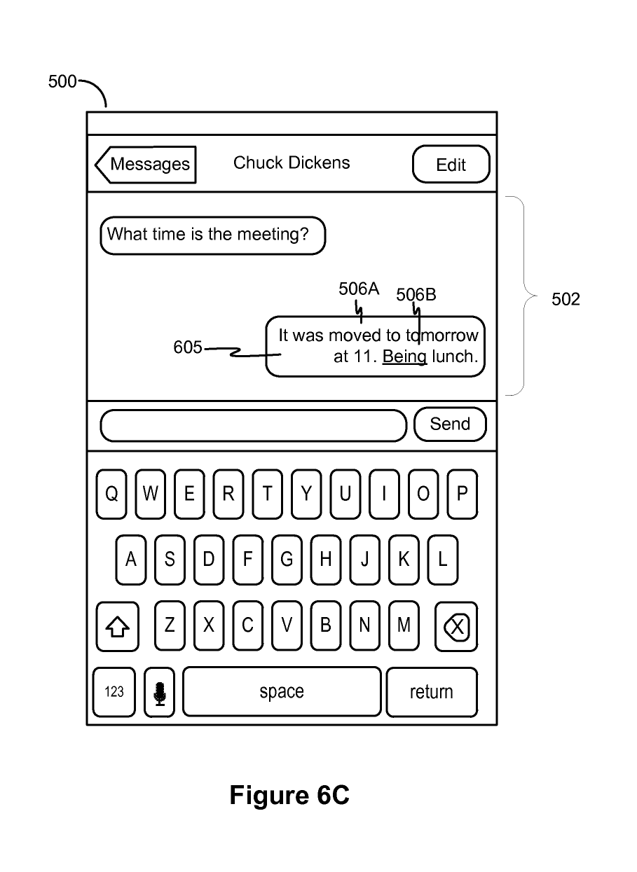

The electronic device sends the modified electronic message to the recipient and displays the sent message in the transcript 502 of the user interface 500. While displaying the sent message, the electronic device visually distinguishes the replacement character string 506A in the sent message from one or more other character strings in the transcript 502. That is, in some embodiments, the electronic device visually distinguishes the replacement character string 506A after the message is sent and can no longer be edited, rather than in a message that can still be edited by the sender. FIGS. 6A-C illustrate various examples of the electronic device visually distinguishing the replacement character string 506A from other strings in the transcript 502. As shown in FIG. 6A, the sent message 605 is displayed in the transcript 502 of the user interface 500. The sent message 605 includes two replacement character strings 506A and 506B (collectively, replacement character strings 506). The replacement character strings 506 are underlined in the transcript 502, while other character strings (e.g., adjacent character strings in the message 605) are not underlined. Thus, the replacement character strings 506 are visually distinguished from other character strings in the transcript 502. The electronic device may visually distinguish the replacement character strings 506 from other character strings in the transcript 502 by displaying the replacement character strings in one or more of a different font, a different font size, a different font style, a different font color, or a different highlighting than the other character strings in the transcript. By visually distinguishing a replacement character string from other strings in the transcript, the electronic device emphasizes the replacement character string and, as a result, notifies the sender of the message that the message includes a character string that is different from the character string entered by the user. This notification reduces the cognitive burden on the sender of an electronic message and improves the efficiency of the sender when using the electronic device, thereby reducing energy use and increasing battery life of the electronic device.

As described above, the replacement character strings 506 may be user-selected or user-confirmed (collectively, user-selected) corrections of entered character strings or may be automatic corrections of entered character strings selected by the electronic device. In some embodiments, a user-selected replacement string 506A and the auto-corrected string 506B are visually distinguished from other strings in the transcript 502 in the same way. For example, if the replacement string 506A is a user-selected correction and the replacement string 506B is an autocorrection, both replacement strings 506 are underlined in FIG. 6A, while other strings in the transcript 502 are not underlined. In some embodiments, user-selected corrections are visually distinguished from auto-corrections. For example, in FIG. 6B, the user-selected replacement string 506A is underlined and italicized in the transcript 502, while the auto-corrected character string 506B is underlined in the transcript 502. In some embodiments, user-selected corrections are not visually distinguished from other character strings in the transcript 502. For example, as shown in FIG. 6C, the user-selected replacement string 506A is displayed in the same way as other character strings in the message 605, while only the auto-corrected character string 506B is visually distinguished from the other character strings.

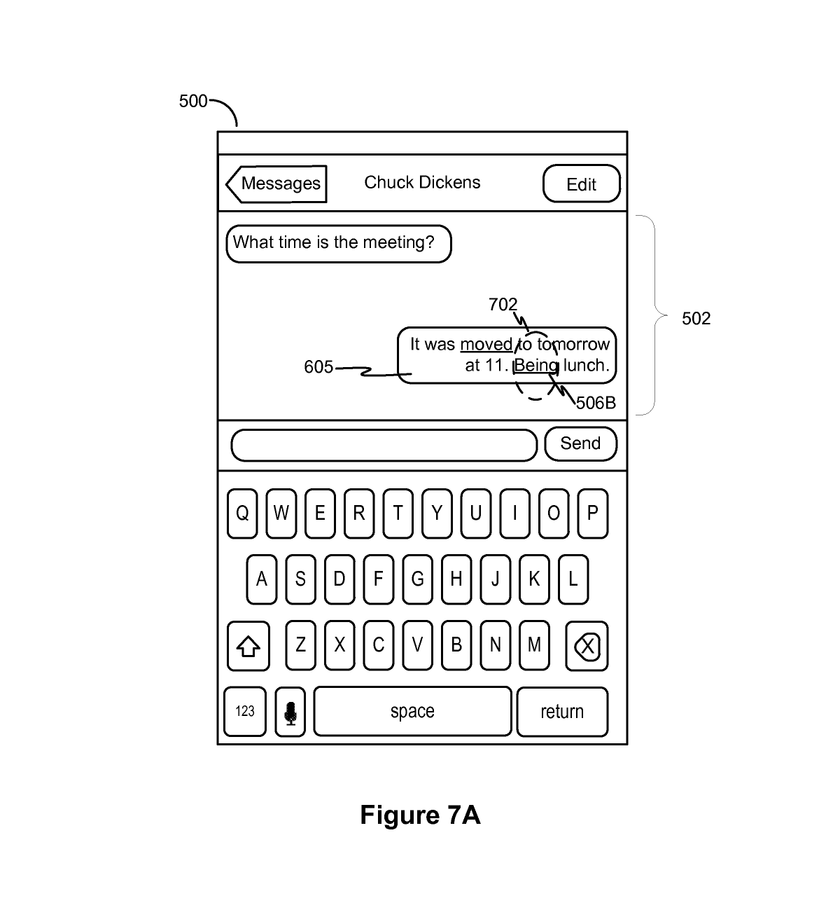

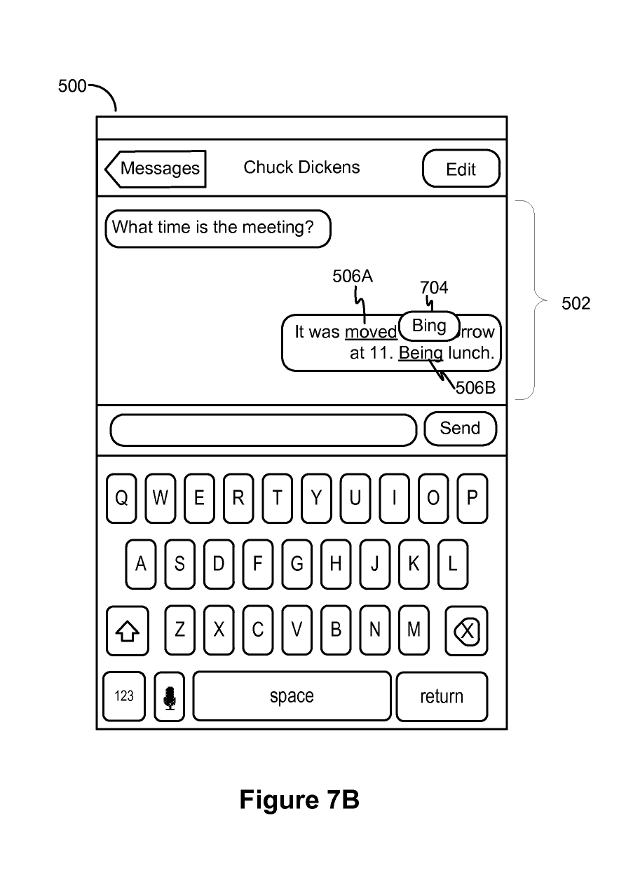

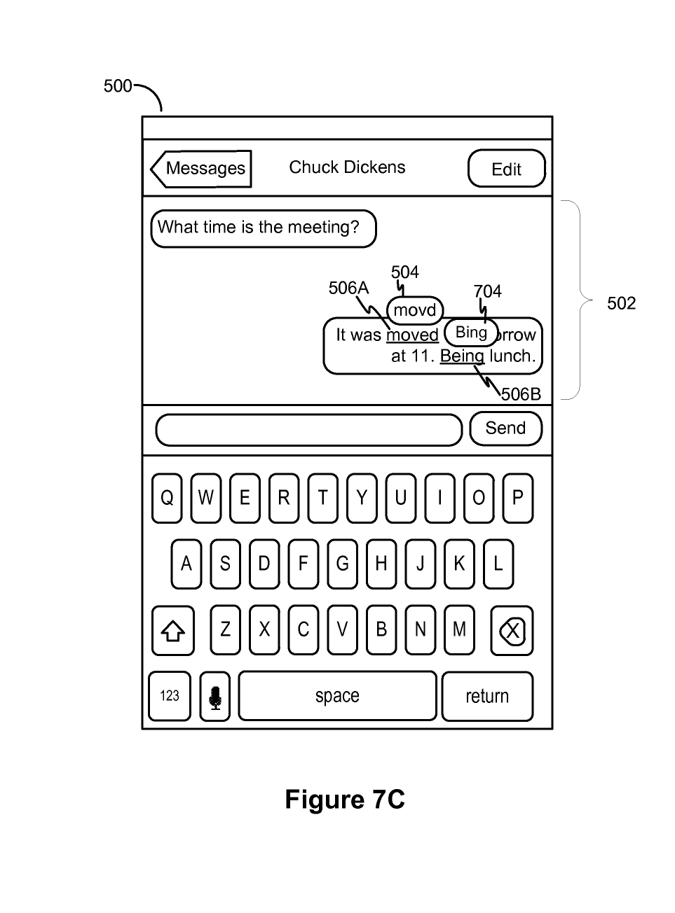

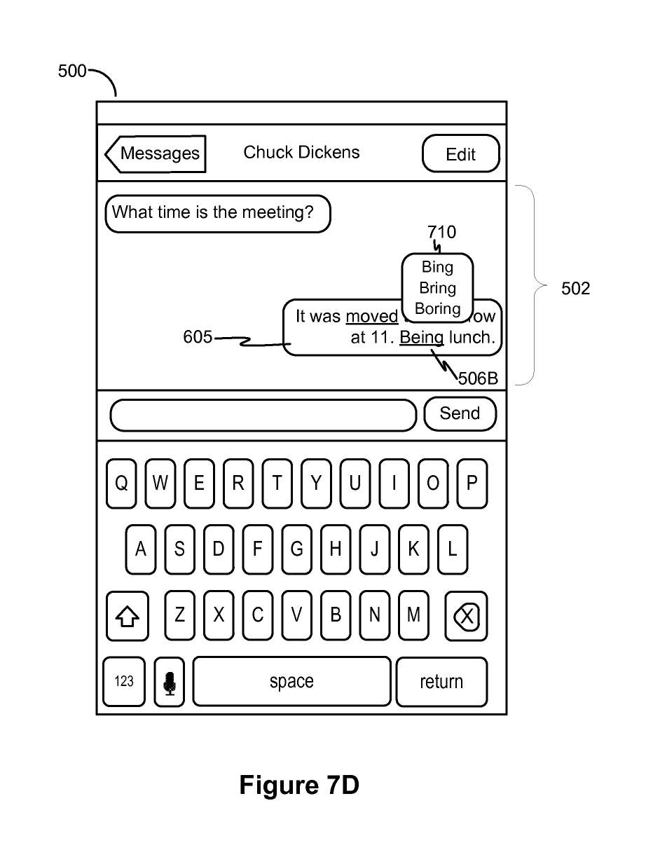

In some embodiments, the user interface 500 is interactive and displays the entered character string (or multiple entered character strings) or candidate replacement character strings corresponding to a replacement character string in response to a user input that corresponds to a location within the user interface 500. FIGS. 7A-D illustrate example user inputs and entered character strings or candidate replacement character strings displayed in response to the example user inputs. In FIG. 7A, an input is detected that corresponds to a location of a replacement character string 506 displayed in the transcript 502. For example, the electronic device receives a touch input 702 at the location of the replacement character string 506B in the transcript 502. The touch input 702 is, for example, a finger tap at the location of the replacement character string 506B or a touch-and-hold input at the location of the replacement character string 506B. The input may alternatively be a click, a click-and- hold input, or other inputs corresponding to the location of the replacement character string 506B.

In response to detecting the input 702, the electronic device displays the entered character string (or multiple entered character strings) (i.e., the character string(s) replaced by the replacement string 506B) concurrently with the transcript 502. In some embodiments, as shown for example in FIG. 7B, the entered character string 704 corresponding to the selected replacement string is displayed above the replacement character string 506B. The entered character string 704 may alternatively be displayed at other locations near the replacement character string 506B, such as below the replacement character string 506B or to the left or right of the replacement string 506B. In some embodiments, the entered character string 704 is overlaid on the selected replacement string 506B. The entered character string 704 may alternatively be displayed at other locations in the user interface 500.

A sent message may include multiple replacement character strings replacing multiple respective entered character strings. In some embodiments, when a user input is received at the location of one of the replacement character strings 506 in a displayed message, the entered character string (or multiple entered character strings) corresponding to the selected replacement string is displayed while the other replacement character strings in the message are displayed. For example, in FIG. 7B, the entered character string 704 is displayed in response to the user input 702 received at the replacement character string 506B. The replacement character string 506A is displayed, but the entered character string corresponding to the replacement character string 506A is not displayed in response to the user input 702. However, in some embodiments, a plurality of entered character strings are displayed in response to the user input at one of the replacement character strings in a message. For example, FIG. 7C illustrates the entered character string 704 (corresponding to the replacement character string 506B) and the entered character string 504 (corresponding to the replacement character string 506A) displayed in response to the user input 702 shown in FIG. 7A. By displaying entered character strings in response to a user input received at a location of a replacement character string, the electronic device enables the sender of an electronic message to quickly and easily determine the entered character string (or multiple entered character strings). The entered character string(s) displayed to the sender may remind the sender of what it was the sender intended to type or clarify for the sender why the entered character string was replaced with the replacement character string. Accordingly, the electronic device according to some embodiments reduces confusion of the sender and improves the efficiency of the sender's use of the electronic device, thereby reducing energy use and increasing battery life of the electronic device.

In some embodiments, if a replacement character string was selected from a set of candidate replacement character strings, one or more of the candidate replacement strings is displayed in response to a user input at the replacement character string displayed in a message. For example, FIG. 7D illustrates a set 710 of candidate strings displayed in response to a user input received at the replacement character string 506B. The candidate string set 710 includes character strings considered by the electronic device for an autocorrection of the entered character string 704. The set 710 of candidate strings includes at least one character string that is neither the string entered by the sender of the message 605 nor the replacement character string 506B, but may also include the entered character string 704 (or multiple entered character strings) or the replacement character string 506B.

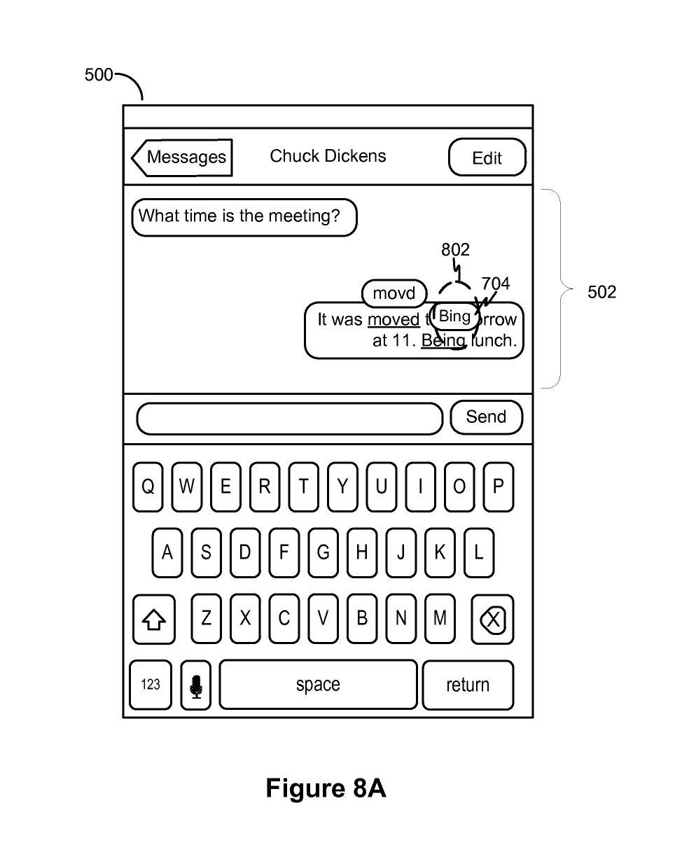

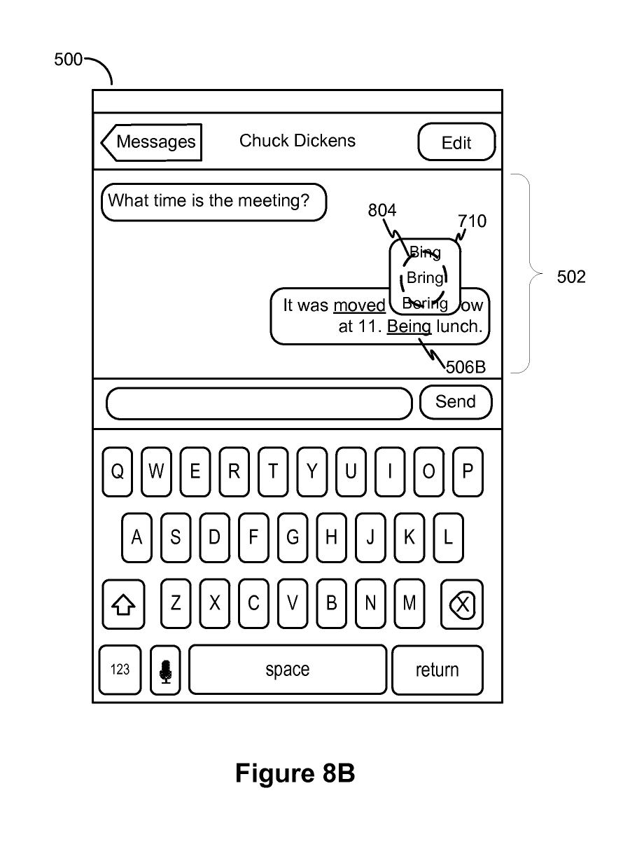

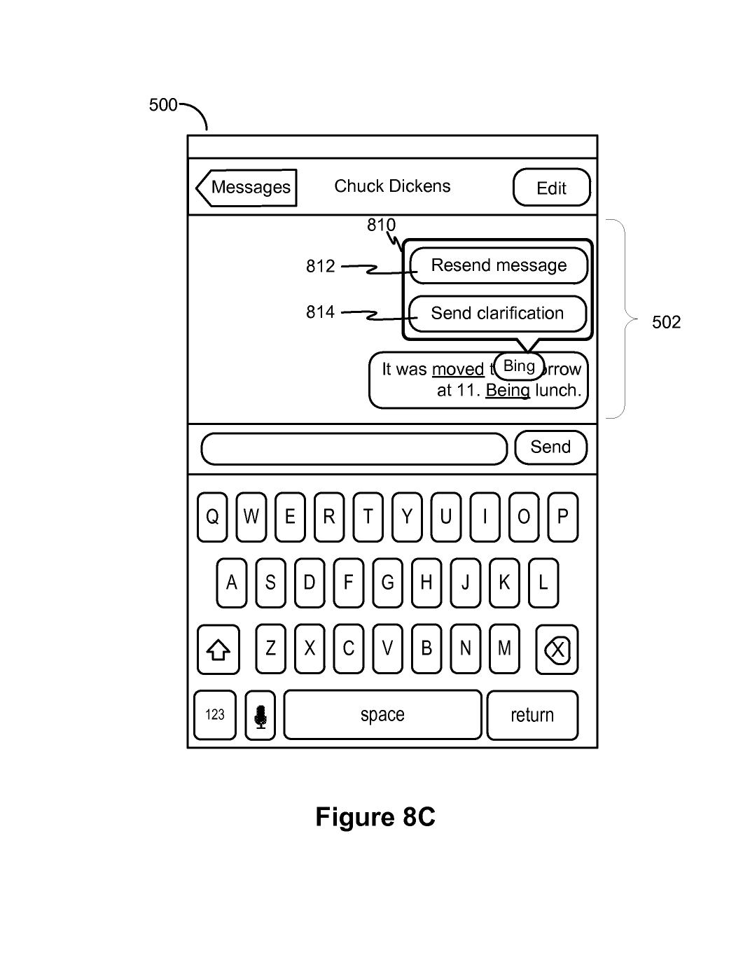

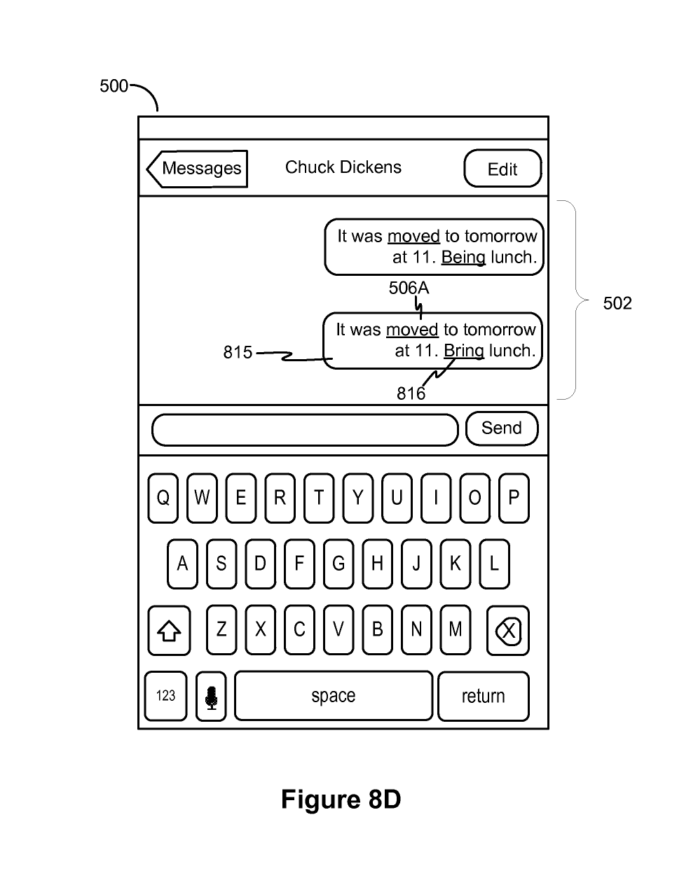

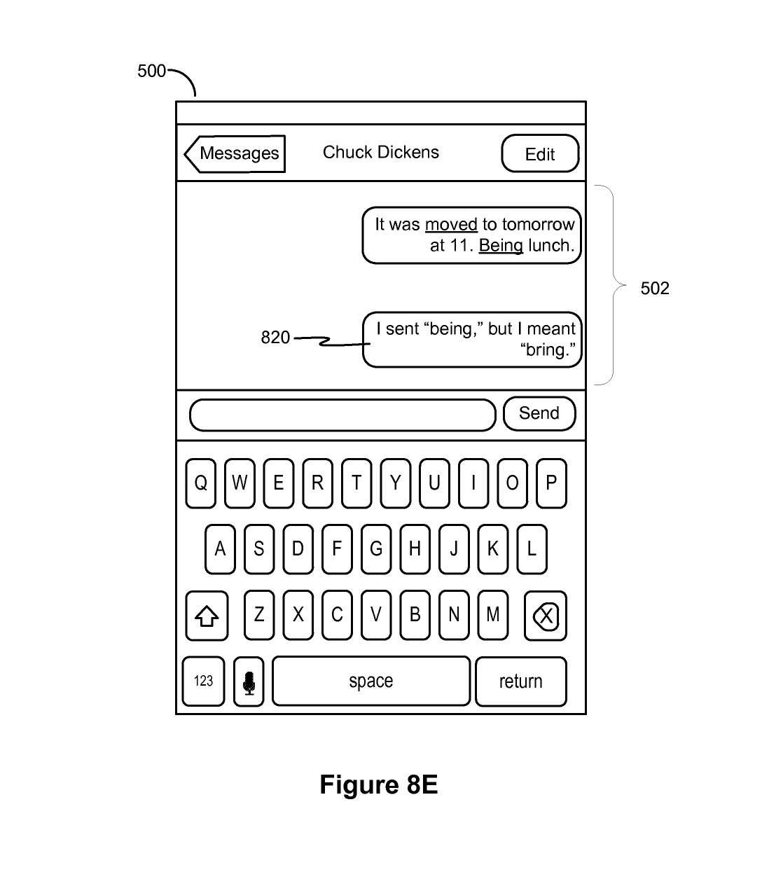

In some embodiments, the user interface 500 provides an option for the sender of an electronic message to send a second message to correct or explain a replacement string in the first message 605. FIGS. 8A-E illustrate example inputs for sending corrections or explanations to a recipient of the message 605, as well as example messages sent to the recipient to correct or explain a replacement character string.

In the example of FIG. 8A, the entered character string 704 displayed in the user interface 500 functions as an option to send a second electronic message containing the entered character string 704. When a user input 802 is received at the entered character string 704, the user input 802 is interpreted as a selection of an option to send a second electronic message. The input 802 may include any of a variety of interactions with the entered character string 704. If the electronic device displaying the user interface 500 includes a touch-sensitive display, the user input 802 may be a tap input at the entered string 704, a tap-and-hold input at the entered string 704, or a tap input at the entered string 704 followed by a selection of an option from a menu displayed in response to the tap input. Alternatively, the user input 802 may be a click input at the entered string 704, a click-and-hold input at the entered string 704, or a click input followed by a selection from a menu.

FIG. 8B illustrates another example user input 804 received at a set 710 of candidate replacement character strings. The user input 804 is a selection of one of the candidate replacement character strings in the candidate string set 710, and may be any of a variety of touch or mouse inputs at the candidate replacement character string. The user input 804 is interpreted as command to send a second electronic message containing a selected replacement string from the candidate string set 710.

In some embodiments, in response to the user input 802 or 804, the electronic device displays a menu 810 as shown in FIG. 8C. The menu 810 provides the user with an option 812 to resend the electronic message 605 with the entered character string or the selected candidate replacement character string in place of the replacement character string 506B and an option 814 to send a clarification message specifying the replacement character string 506B was intended to be the entered character string or the selected candidate replacement character string. In some embodiments, in response to receiving a user selection of the option 812 or the option 814, the electronic device sends a notification to the recipient of the electronic message 605 indicating that a corrective or clarification message is about to be sent to the recipient.

In response to receiving a user input at the option 812 to resend the electronic message 605, the electronic device sends a corrective electronic message to the recipient of the electronic message 605. The corrective electronic message may include an identifier of the electronic message 605, enabling the recipient device to identify the electronic message 605 being corrected by the corrective message. The corrective message has identical text to the message 605, except the replacement character string 506B is replaced by the entered character string 704 or the selected candidate replacement character string. If a message includes multiple replacement character strings, the corrective message may include each replacement character string in the message replaced by a corresponding entered character string, or the sender may select one or more of the replacement character strings in the message to be replaced by corresponding entered character strings in the corrective message. FIG. 8D illustrates an example corrective message 815 sent to the recipient in response to the user selection of the option 812. The corrective message 815 includes a selected candidate replacement character string 816. The corrective message 815 is added to the transcript 502 of the user interface 500 in some embodiments. Alternatively, in some embodiments, the corrective message 815 is displayed as a notification, overlaid on the transcript 502, or displayed at other locations on the user interface 500. In some embodiments, if the user acknowledges a corrective notification, then the corresponding original message is corrected inline in the displayed transcript 502. The selected candidate replacement character string 816 may be visually distinguished from one or more other character strings in the corrective message 815. The selected candidate replacement character string 816 may be displayed in a similar font, font size, font style, color, and highlighting as a replacement character string in the message 815, such as the replacement character string 506A. Similarly, if a corrective message includes the entered character string 704, the entered character string 704 may be distinguished from one or more other character strings in the corrective message.

In some embodiments, the corrective message 815 is visually distinguished from the sent message 605 or other messages in the transcript 502. For example, the electronic device prefixes the corrective message 815 with a string such as “Correction:”. In some embodiments, the electronic device visually distinguishes the corrective message 815 by displaying corrected strings in the corrective message 815 in a different font, font size, font style, font color, or highlighting than one or more other strings in the transcript 502, or displaying the corrective message 815 in a different background color or outlining than other messages in the transcript 502.

In response to receiving a user input at the option 814 to send a clarification message, the electronic device generates and sends a clarification message to the recipient of the electronic message 605. The clarification message may include an identifier of the electronic message 605, enabling the recipient device to identify the electronic message 605 being clarified. The clarification message indicates that the replacement character string 506B was intended to be the entered character string 704 or the selected candidate replacement string. In some embodiments, the clarification message is a predefined sentence with the replacement character string and entered character string input at the time of sending. For example, the clarification message is a message of the form “I sent ‘<replacement character string>,’ but I meant ‘<entered character string>”’ or a message of the form “I sent ‘<replacement character string>,’ but I meant ‘<selected candidate replacement character string>.’” When a user selects the option 814 to send the clarification message, the electronic device generates the clarification message by replacing the variables <replacement character string>and <entered character string>(or <selected candidate replacement character string>) with, respectively, the replacement character string 506B and the entered character string 704 (or the selected candidate replacement character string) corresponding to the replacement character string 506B. In some embodiments, the clarification message can be selected or defined by the user. Furthermore, if a message includes multiple replacement character strings, the clarification message may clarify each replacement character string in the message, or the sender may select one or more of the replacement character strings in the message for clarification. An example clarification message 820, which includes an identification of the selected candidate replacement character string 816, is illustrated in FIG. 8E. As shown in FIG. 8E, the electronic device may display the clarification message 820 in the transcript 502 after the clarification message is sent to the recipient. Alternatively, in some embodiments, the clarification message 820 is displayed as a notification, overlaid on the transcript 502, or displayed at other locations on the user interface 500. After the user acknowledges the clarification message 820, the replacement character string may be replaced by the entered character string or the selected candidate replacement character string in the electronic message 605.

By providing the sender an option to send a corrective or clarification message to the recipient of the electronic message, the electronic device enables the sender to quickly and easily clarify a potentially confusing replacement character string. In some embodiments, therefore, the electronic device improves the sender's efficiency when using the electronic device (e.g., because the sender does not spend the time to type a new message to clarify the replacement character string). The electronic device also reduces confusion of the recipient and improves the recipient's efficiency when using an electronic device to view the electronic message (e.g., because the recipient does not spend the time to type a new message to request clarification of a confusing replacement character string). Therefore, energy use is decreased at both the sender's electronic device and the recipient's electronic device, increasing the battery life of both devices.

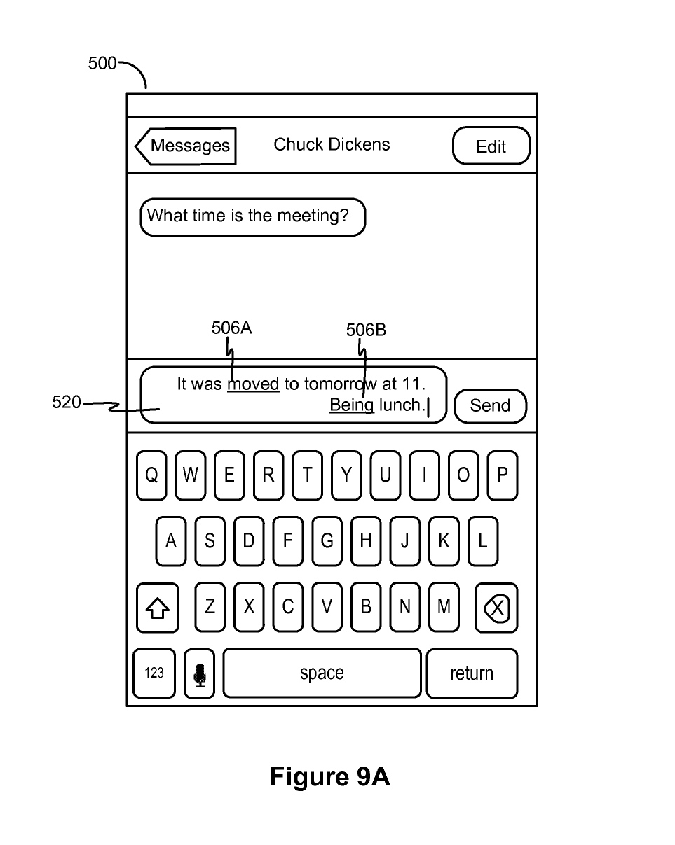

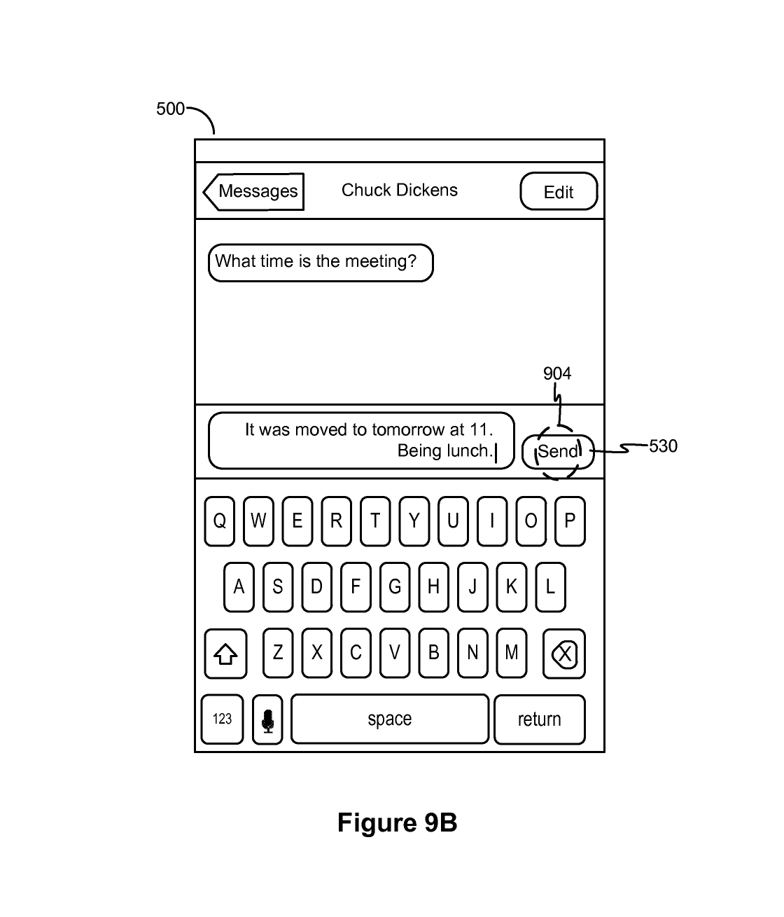

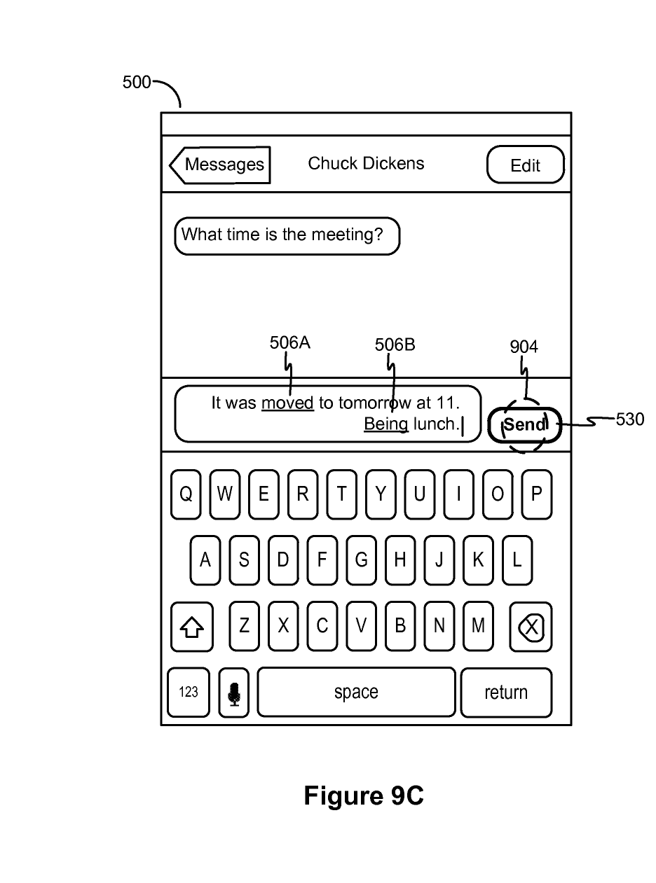

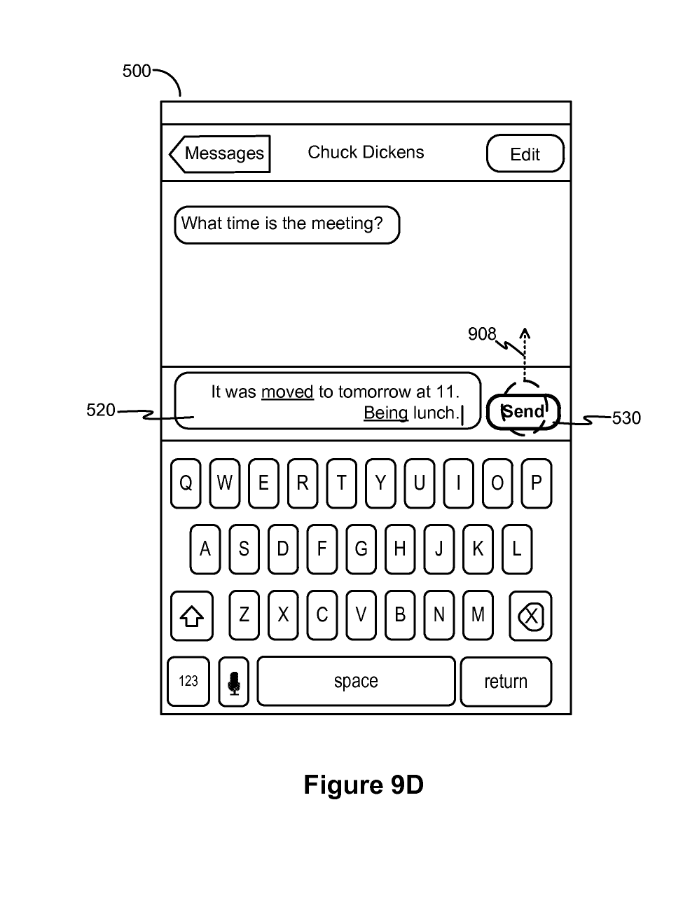

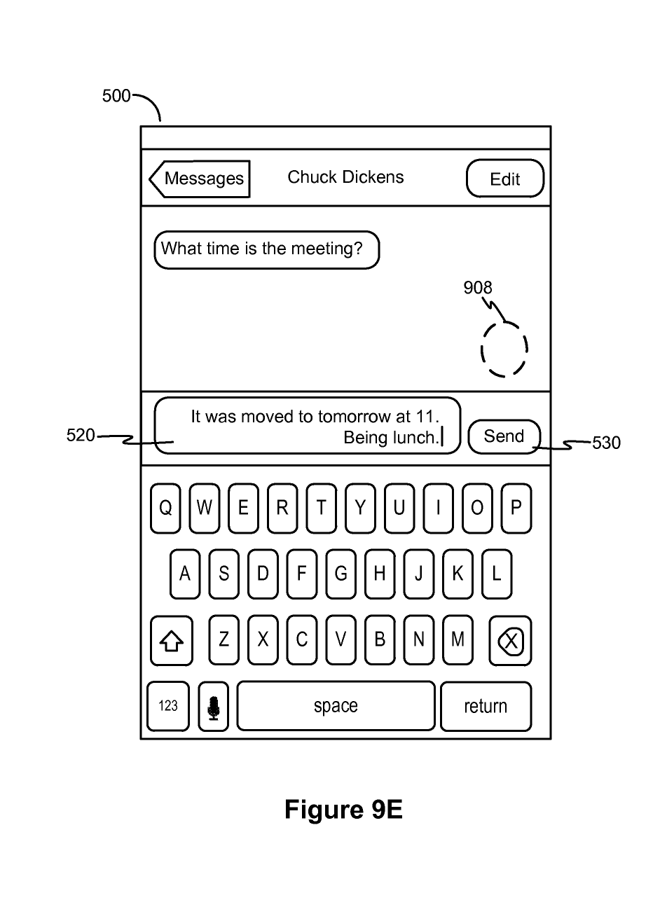

As described above, the text entry box 520 of the user interface 500 displays text of an electronic message as a user enters character strings to draft the message. Accordingly, the text entry box 520 displays a draft electronic message. FIGS. 9A-E illustrate various examples of draft electronic messages displayed in the text entry box 520 of the user interface 500. In some embodiments, the text entry box 520 displays replacement character strings that replaced respective character strings entered by the user.

FIG. 9A illustrates two replacement character strings 506A and 506B displayed as part of a draft electronic message before the message is sent. In some embodiments, the replacement character strings 506 are visually distinguished in the draft electronic message from one or more other character strings in the message. For example, the replacement character strings 506 are displayed in a different font, a different font size, a different font style, a different font color, or a different highlighting than one or more other strings in the draft electronic message. In some embodiments, the electronic device visually distinguishes the replacement character strings 506 from other strings in response to replacing the entered character strings with the corresponding replacement character strings 506. For example, after the user enters the character string “movd” 504 shown in FIG. 5A and enters a space following the character string, the electronic device replaces the entered character string with the replacement character string “moved” 506A and underlines “moved” to distinguish it from the other character strings in the draft electronic message.

In some embodiments, as shown in FIGS. 9B-C, the electronic device visually distinguishes replacement character strings 506 from other strings in a draft electronic message in response to detecting a precursor to an input to send the message. In FIG. 9B, a user input 904 is received at a send button 530 displayed in the user interface 500. For example, a user touches down at the location of the send button 530, which is a precursor to an input to send the message. As shown in FIG. 9C, the electronic device visually distinguishes the replacement character strings 506 from other character strings in the draft message in response to detecting the user input 904 at the send button 530. If the electronic device receives a subsequent send message input (e.g., the user releasing the send button 530), the electronic device sends the message to the recipient with the replacement character strings replacing corresponding entered character strings.

The user may alternatively provide an input to cancel sending of the message. If the electronic device receives an input (after the user input 904) to cancel sending of the message, the electronic device does not send the message to the recipient. As an example of a user input cancelling sending of the message, FIG. 9D illustrates a user input 908, which is received after the user input 904, sliding away from the send button 530. In the example embodiment illustrated in FIG. 9D, the electronic device detects the user input 908 sliding away from the send button 530 and, in response, the draft electronic message displayed in the text entry box 520 is not sent to the recipient. FIG. 9E illustrates the user input 908 has slid out of the send button 530, and the draft electronic message displayed in the text entry box 520 has not been sent to the recipient.

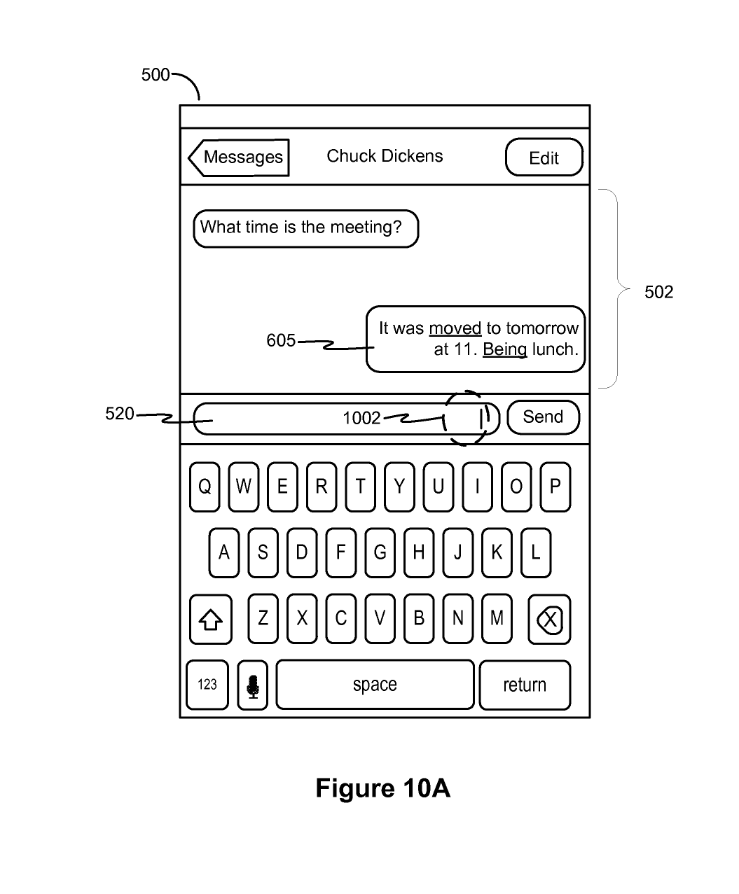

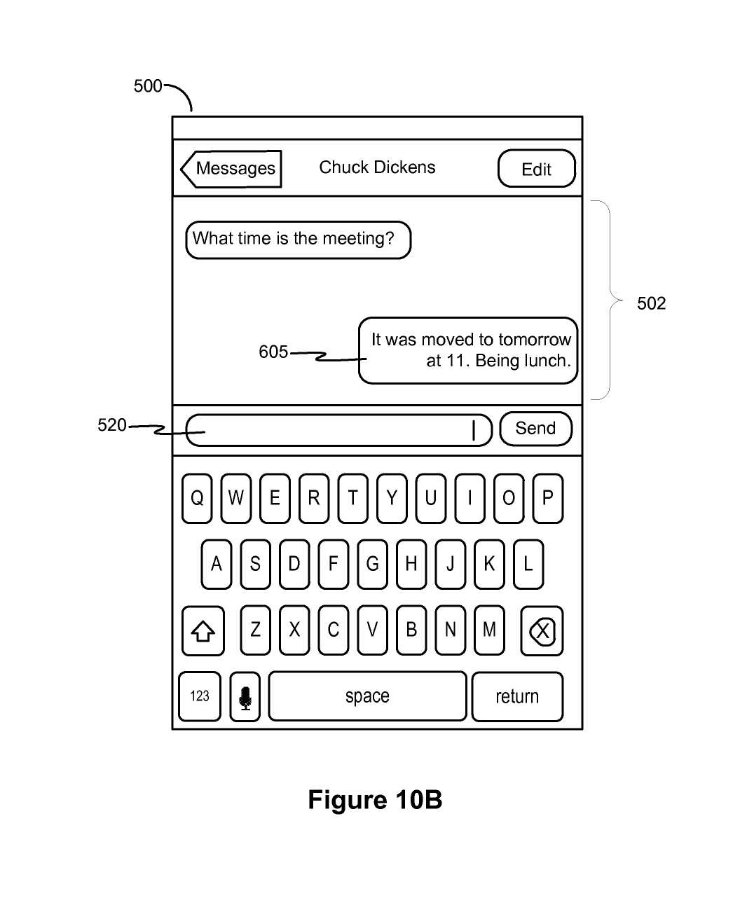

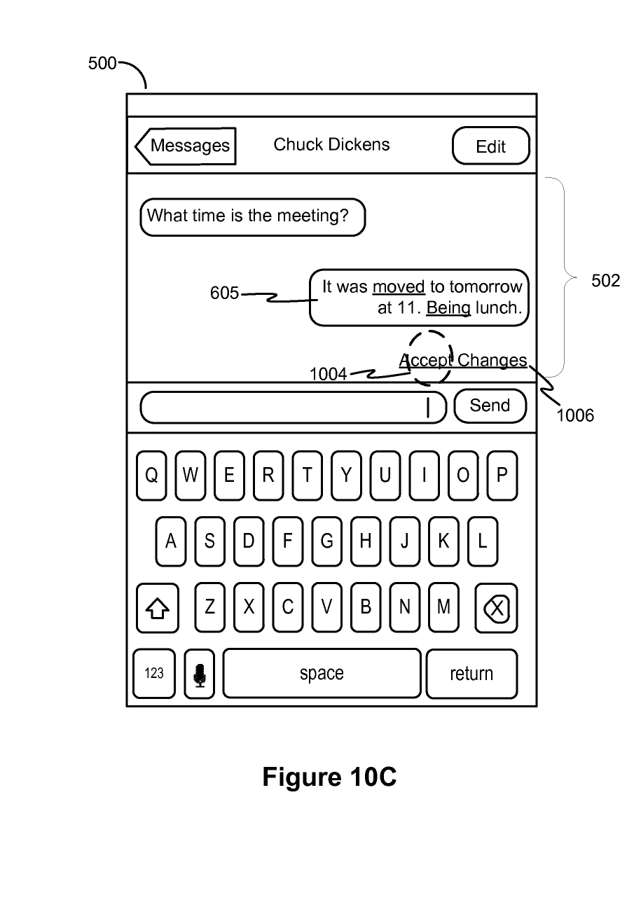

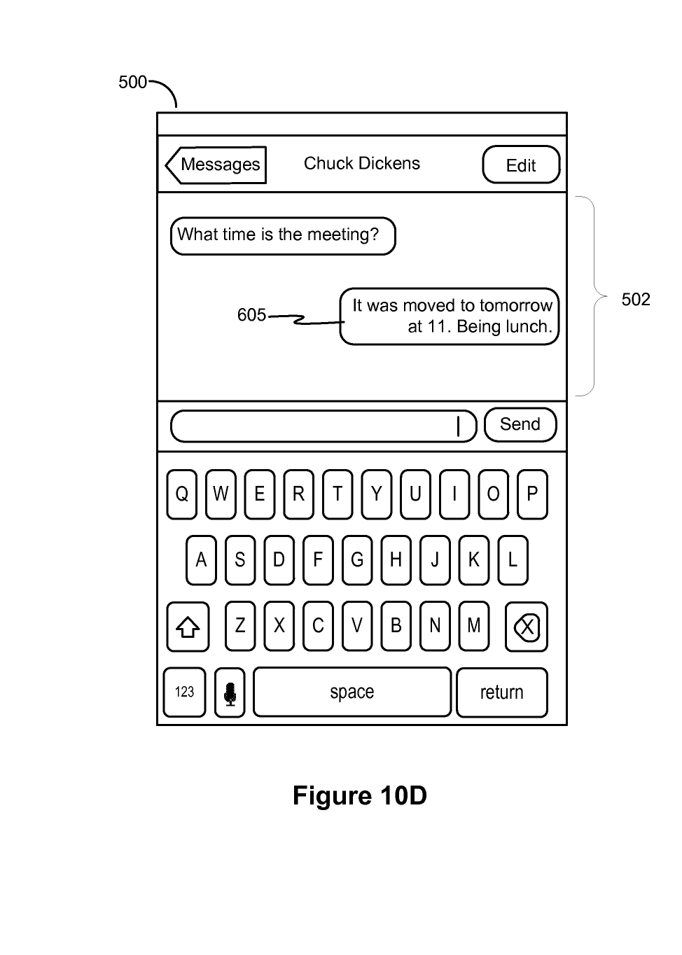

In some embodiments, the visual distinction of replacement character strings in the transcript 502 is turned off in response to receiving a user input. FIGS. 10A-D illustrate various examples of user inputs to turn off the visual distinction of replacement character strings. In FIG. 10A, a user input 1002 is a command to start composing a new electronic message. For example, the electronic device interprets a tap input at the location of the text entry box 520 as a command to start composing a new electronic message. In response to receiving the input 1002, the message 605 is displayed without visually distinguishing the replacement character strings from other strings in the transcript 502, as shown in FIG. 10B. For example, the replacement character strings are displayed in the same font, font size, font color, and/or highlighting as the other character strings in the transcript 502.

Another example user input to cease visually distinguishing a replacement character string is illustrated in FIG. 10C. A user input 1004 is received at an “accept changes” button 1006 displayed as part of the user interface 500. In response to receiving the input 1004, the message 605 is displayed without visually distinguishing the replacement character strings from other strings in the transcript 502, as shown in FIG. 10D. In some embodiments, after the electronic device ceases to visually distinguish a replacement character string, the electronic device may again visually distinguish the replacement character string in response to a user selection of the electronic message 605, in response to a user selection of a “show changes” button (not shown), or in response to other user inputs.

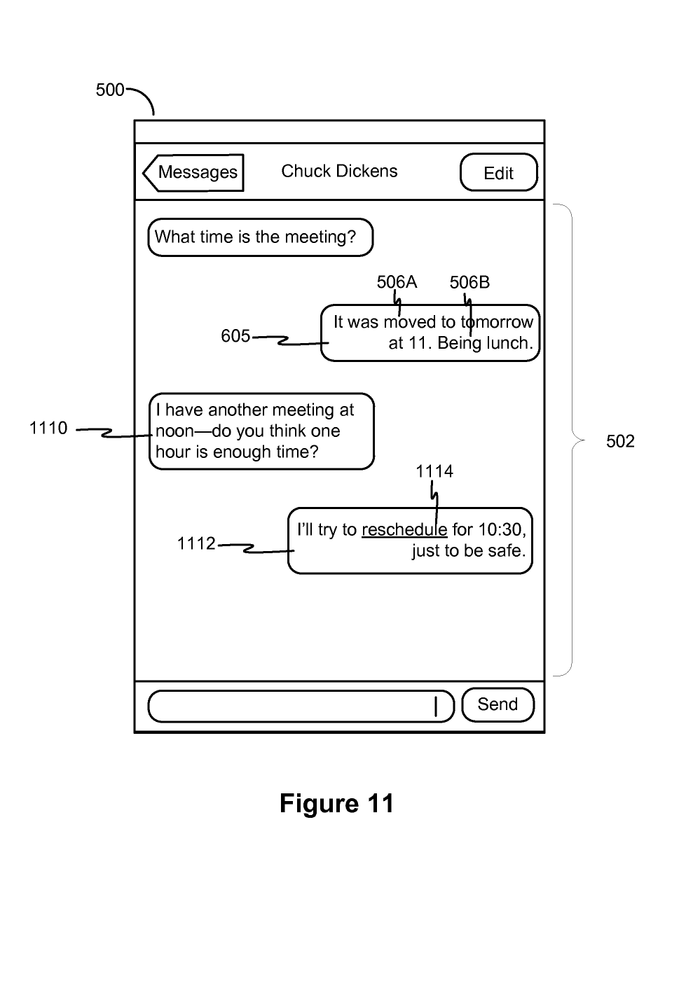

In some embodiments, replacement character strings are distinguished from other character strings in the transcript 502 for a most recent message but are not distinguished for older messages in the transcript 502. FIG. 11 illustrates the transcript 502 including a message 1110 sent to the user of the interface 500 after the message 605 was sent, as well as a message 1112 sent by the user after receiving the message 1110. As shown in FIG. 11, a replacement string 1114 is visually distinguished in the message 1112 from other strings in the transcript 502. The replacement strings 506 in the message 605 are displayed in the same way as other strings in the transcript 502.

### Receiver-Side User Interfaces

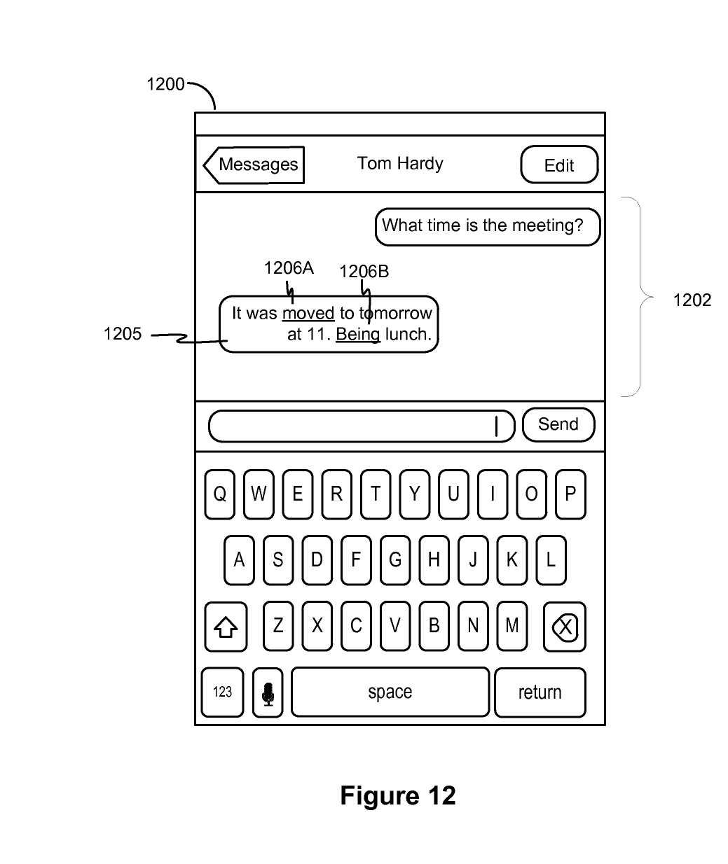

FIG. 12 illustrates a user interface 1200 displayed by an electronic device used by a recipient of an electronic message. The user interface 1200 displays electronic messages sent to a user. In some embodiments, one or more electronic messages received by or sent by the user of the interface 1200 are displayed as part of a transcript 1202. Embodiments of the user interface 1200 may be similar to embodiments of the user interface 500 described above.

The message 1205 displayed by the interface 1200 is an example electronic message received by the user of the interface 1200. The electronic message 1205 includes replacement character strings 1206A and 1206B that replaced corresponding character strings entered by the sender before the message was sent. In some embodiments, the replacement character strings 1206 are corrections to entered character strings accepted by the sender of the message 1205 and are not proposed changes to the message 1205 that can be reverted by the recipient.

The replacement character strings 1206 are visually distinguished from one or more other strings in the electronic message 1205. For example, the replacement character strings 1206 are visually distinguished from the character strings adjacent to the replacement strings 1206 in the message 1205. To visually distinguish the replacement character strings 1206 from other strings, the electronic device displaying the user interface 1200 may display the replacement character strings 1206 in a different font, a different font size, a different font style, a different font color, or a different highlighting than the other strings in the message 1205.

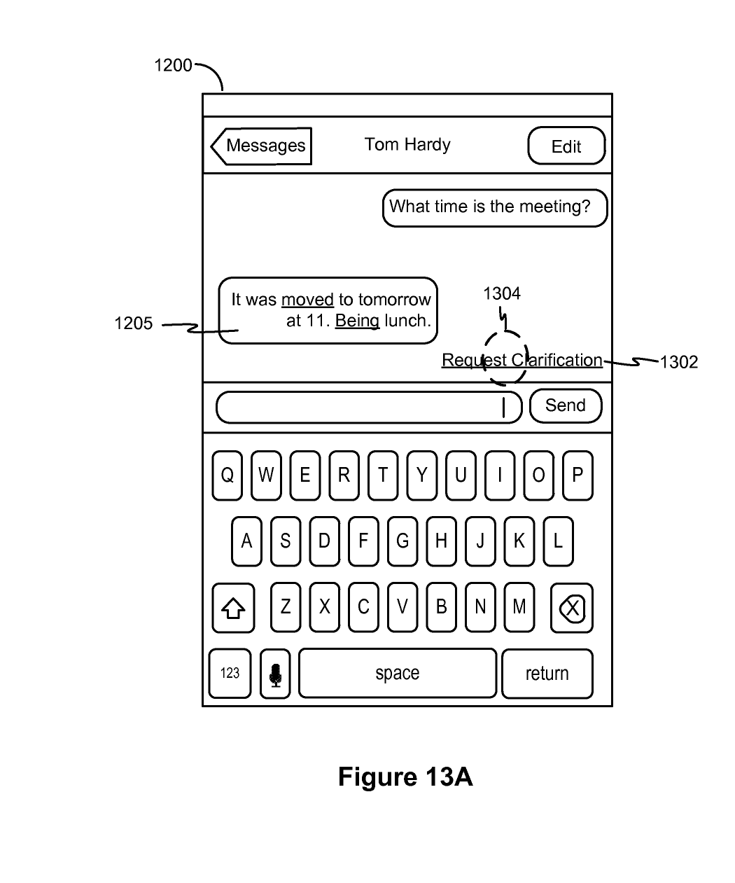

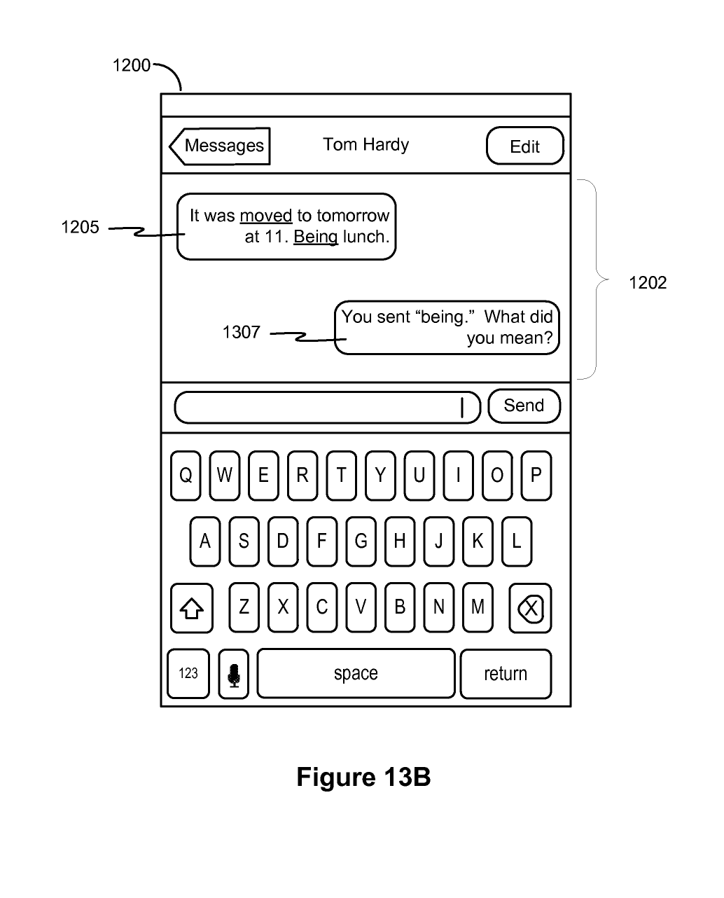

In some embodiments, the user interface 1200 provides an option to a user of the interface to request clarification of the replacement character string. FIGS. 13A-B illustrate an example user input to request clarification from the sender of the electronic message 1205 and a clarification message sent in response to the user input. As shown in FIG. 13A, some embodiments of the user interface 1200 include an element 1302 to request clarification. In response to a user input at the clarification request element 1302, such as a touch input 1304 at the location of the element 1302, the device requests clarification from the sender of the message 1205. For example, the device sends a clarification request to the sender to request that the sender clarify one or more of the replacement strings in the message.

FIG. 13B illustrates an example clarification request 1307 sent to a sender of the message 1205 in response to the user input 1304. In some embodiments, a clarification request is a predefined electronic message generated by the device executing the user interface 1200 and includes an indication of the replacement character string. For example, in response to the user input 1304, the device generates a message of the form “You sent <replacement character string>. What did you mean?” In response to the user input 1304 at the clarification request element 1302, the electronic device generates a message by replacing the variable <replacement character string>with one or more of the replacement character strings 1206 displayed in the electronic message 1205. If an electronic message includes multiple replacement strings, a recipient of the message may select one or more of the replacement strings for which to request clarification. In the example of FIGS. 13A-B, the user requests clarification for the replacement character string “Being” 1206B. After sending the clarification request 1307 to the sender of the electronic message 1205, the electronic device may display the clarification request 1307 in the transcript 1202 containing the electronic message 1205.

By sending a clarification request to the sender of the electronic message, the electronic device enables the recipient to quickly and easily request clarification for a confusing replacement character string. In some embodiments, therefore, the electronic device improves the recipient's efficiency when using the electronic device (e.g., because the recipient does not spend time to type a new message to request clarification). As a result, energy use of the electronic device is decreased and the battery life of the device is increased.

If the electronic device used by a recipient of an electronic message receives a corrective or clarification message (e.g., the corrective message 815 shown in FIG. 8D or the clarification message 820 shown in FIG. 8E), some embodiments of the electronic device indicate the original message in the transcript 1202 that is being corrected or clarified (in addition to displaying the corrective or clarification message itself). For example, the electronic message 1205 is highlighted or outlined to visually distinguish the electronic message 1205 from other messages in the transcript. Since the sender or recipient may send multiple electronic messages before the sender sends the corrective or clarification message, indicating the message that is being corrected or clarified improves the recipient's understanding of the corrective or clarification message.

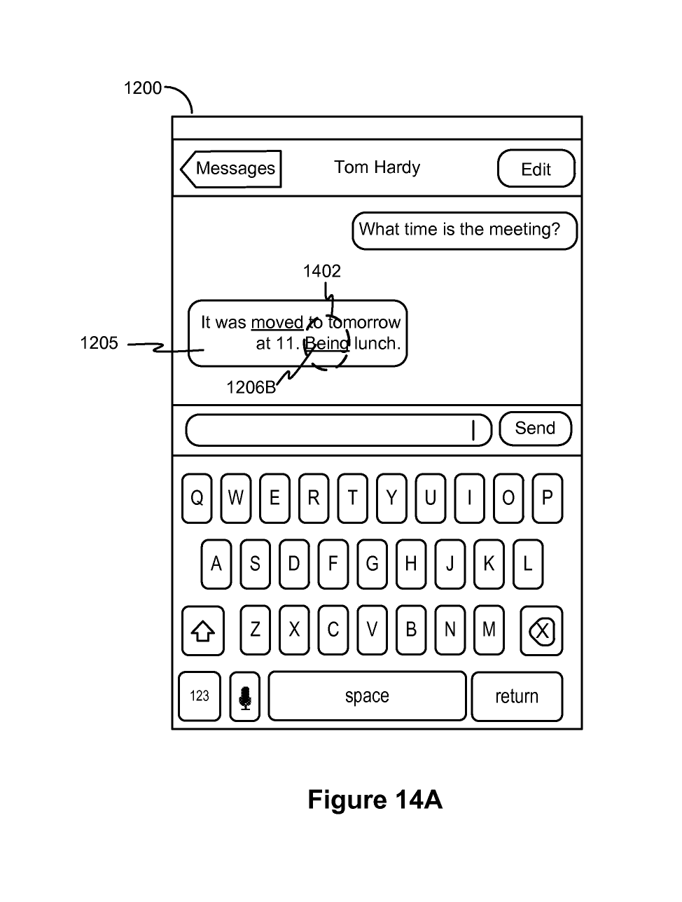

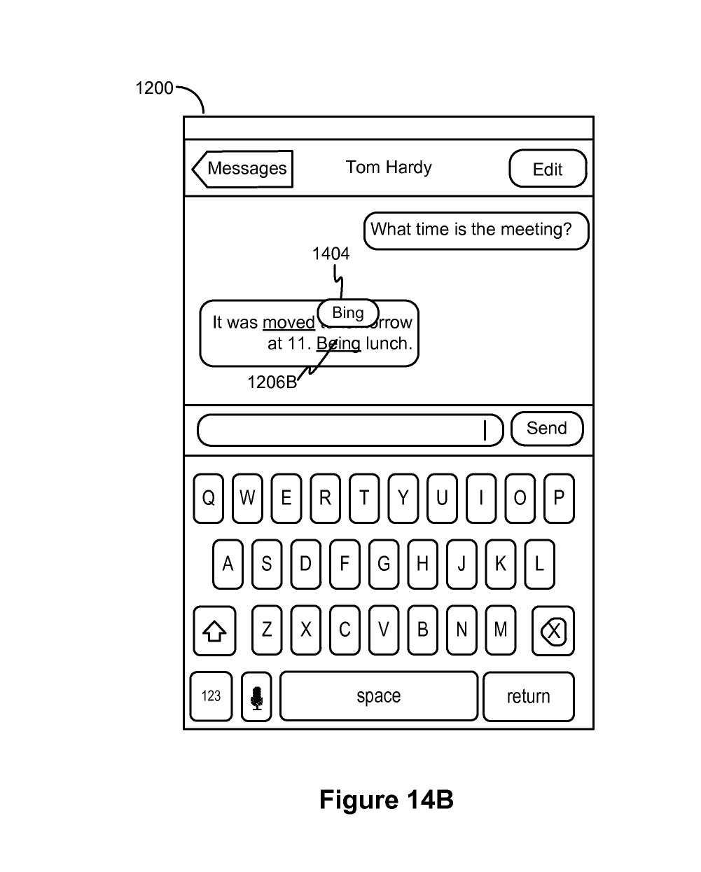

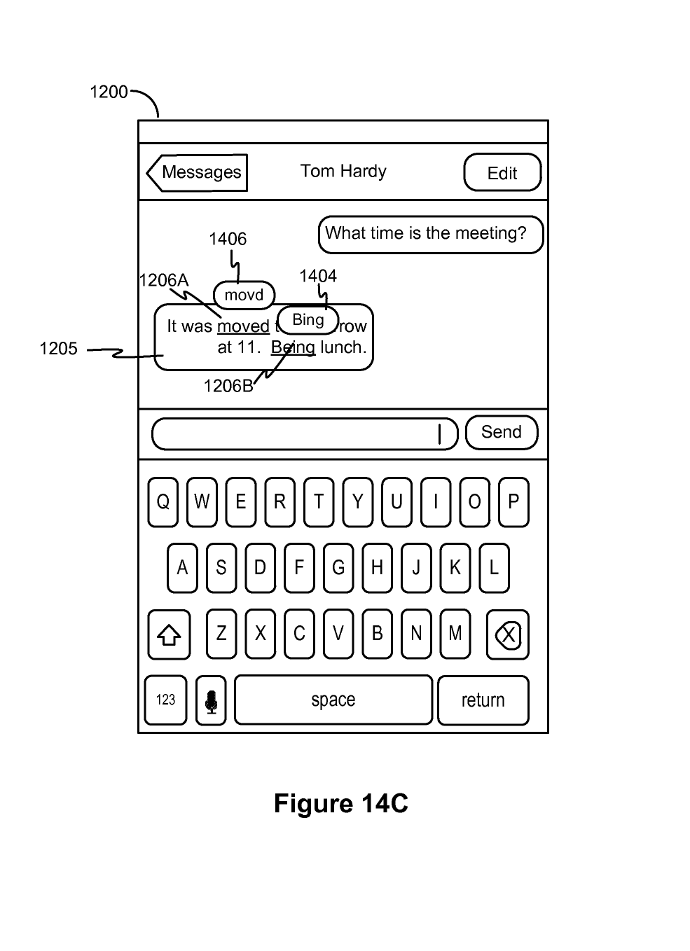

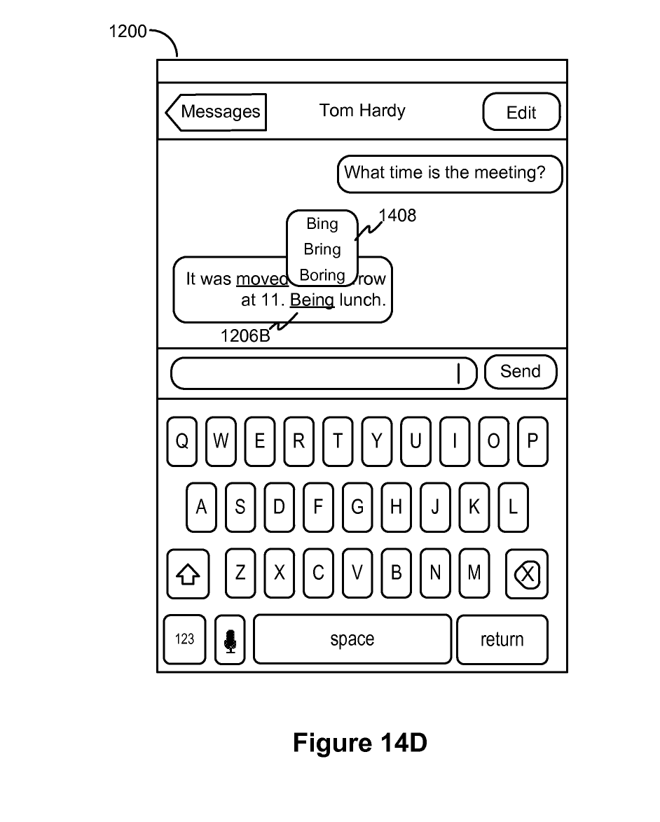

In some embodiments, the user interface 1200 is interactive and displays the entered character strings or candidate replacement character strings corresponding to replacement character strings in a message in response to user inputs received at the user interface 1200. FIGS. 14A-D illustrate example user inputs and entered character strings or candidate replacement character strings displayed in response to the example user inputs. As shown in FIG. 14A, the device receives a user input that corresponds to a location of a replacement character string in a message, such as the touch input 1402 at the replacement character string 1206B in the message 1205. The touch input 1402 is, for example, a finger tap at the location of the replacement character string 1206B or a touch-and-hold input at the location of the replacement character string 1206B. The input may alternatively be a click, a click-and-hold input, or other inputs corresponding to the location of the replacement character string 1206B.

In response to detecting the input 1402, the electronic device displays the entered character string (or multiple entered character strings) concurrently with the transcript 1202. In some embodiments, as shown for example in FIG. 14B, the entered character string 1404 corresponding to the selected replacement string 1206B is displayed near the replacement string 1206B. For example, the entered character string 1404 is displayed above the replacement character string 1206B in FIG. 14B, although the entered character string 1404 may alternatively be displayed below the replacement character string 1206B, to the left or right of the replacement character string 1206B, overlaid on the replacement character string 1206B, or displayed at other locations in the user interface 1200. In some embodiments, the electronic device displays the entered character string 1404 for a specified period of time. After displaying the entered character string 1404 for the specified period of time, the electronic device ceases displaying the entered character string. For example, the electronic device automatically ceases displaying the entered character string in response to determining that the specified period of time has elapsed, without further user intervention.

If a received message includes multiple replacement character strings, some embodiments of the user interface 1200 display the entered character string (or multiple entered character strings) corresponding to a selected replacement character string while the other replacement character strings in the message are displayed. For example, in FIG. 14B, the entered character string 1404 is displayed in response to the user input 1402 received at the location of the replacement character string 1206B. The entered character string corresponding to the replacement character string 1206A is not displayed in response to the user input 1402. In some embodiments, if the message 1205 includes multiple replacement strings, the electronic device displays a plurality of the entered character strings in a message in response to receiving the user input 1402. For example, FIG. 14C illustrates the user interface 1200 displaying entered character strings 1404 and 1406, corresponding to the two replacement character strings 1206 in the message 1205.

In some embodiments, if a replacement character string included in a received electronic message was selected by the sender's electronic device from a set of candidate replacement character strings, the user interface 1200 displays the set of candidate strings in response to the user input 1402. For example, FIG. 14D illustrates a set 1408 of candidate strings corresponding to the selected replacement string 1206B. The candidate string set 1408 may include the entered character string 1404 (or multiple entered character strings) and the replacement character string 1206B, but also includes at least one other character string that is not the entered string or the replacement string.

In some embodiments, the entered character string 1404 (or multiple entered character strings) or the set 1408 of candidate replacement character strings in the electronic message 1205 is displayed to the user of the interface 1200 without altering a view of the electronic message on an electronic device of a sender of the message 1205. For example, the user interface 1200 is not a collaborative document editing platform in which the sender's view of the electronic message is the same as the recipient's view and any change made by either the sender or the recipient is displayed to both users. Rather, the interaction of the recipient with the message 1205 does not affect the sender's view of the message 1205. Similarly, in the case that the electronic message 1205 was sent to a plurality of recipients, the entered character string 1404 (or multiple entered character strings) or the set 1408 of candidate replacement character strings in the electronic message 1205 may be displayed to one of the recipients without altering a view of the message 1205 on electronic devices of other recipients in the plurality of recipients. Thus, the entered character string (or multiple entered character strings) or set of candidate replacement character strings is displayed to the recipient to improve the recipient's understanding of the electronic message, not to enable the recipient to edit an electronic message created by the sender. The entered character string (or multiple entered character strings) or set of candidate replacement character strings may also reduce confusion of the recipient and improve the recipient's efficiency when using the electronic device. Thus, energy use of the electronic device is reduced and battery life is increased.

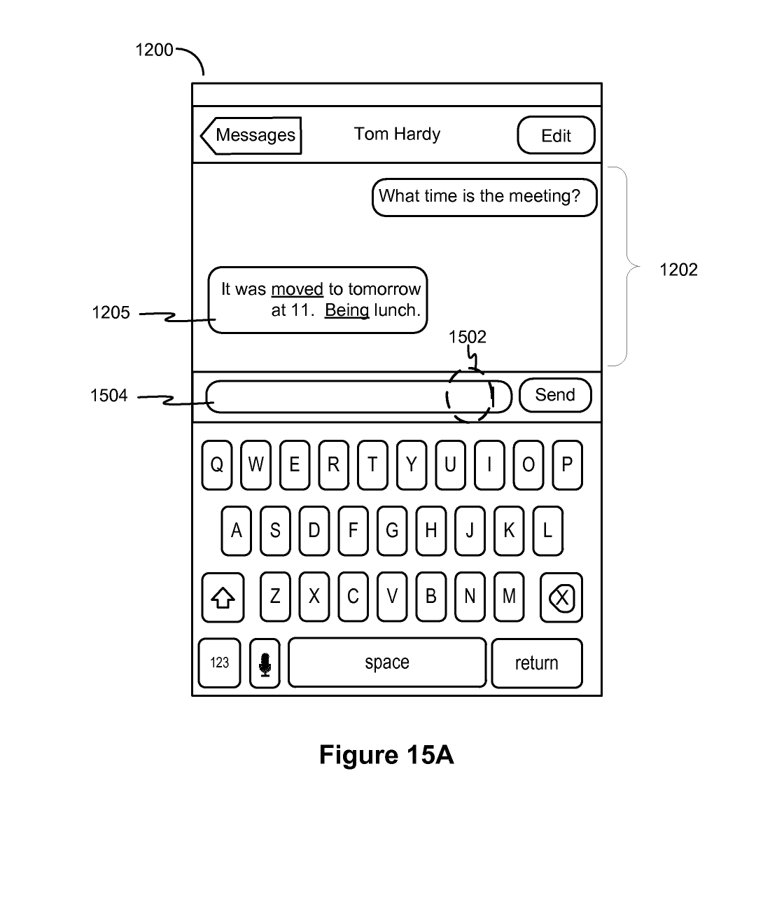

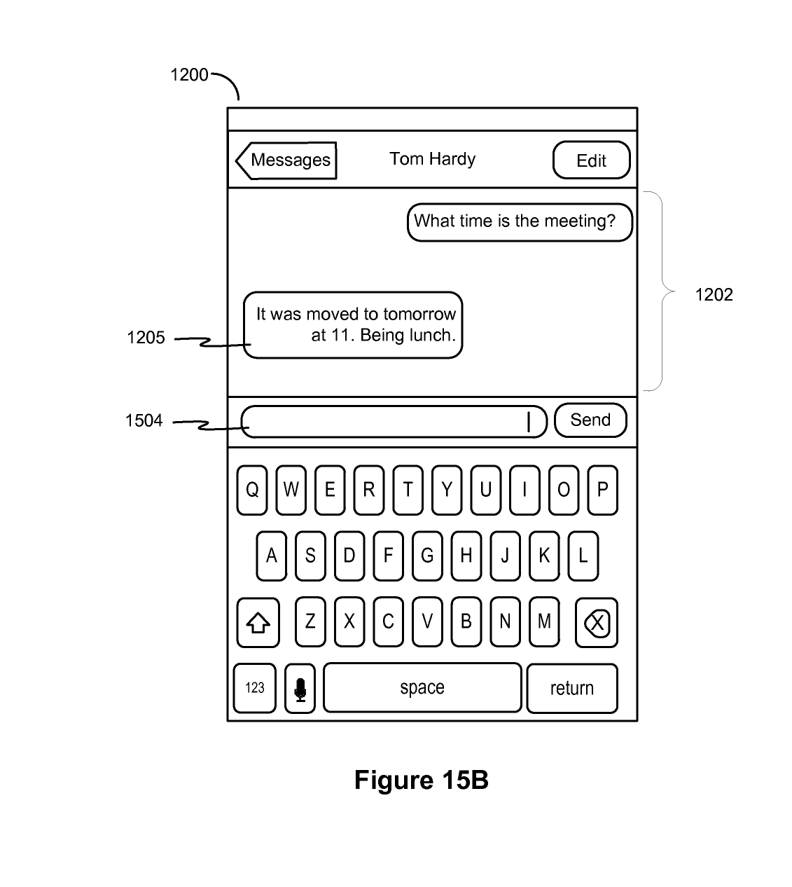

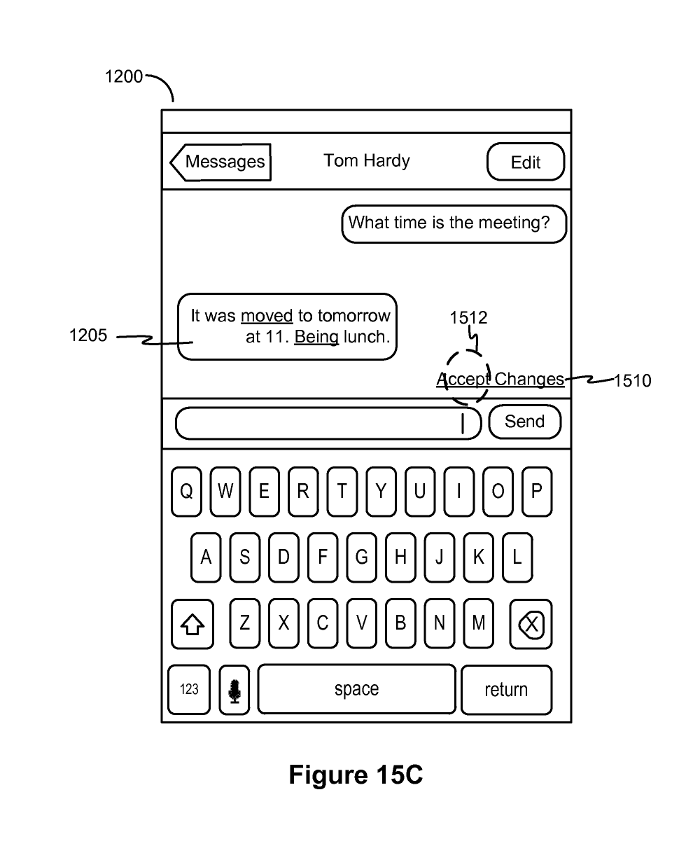

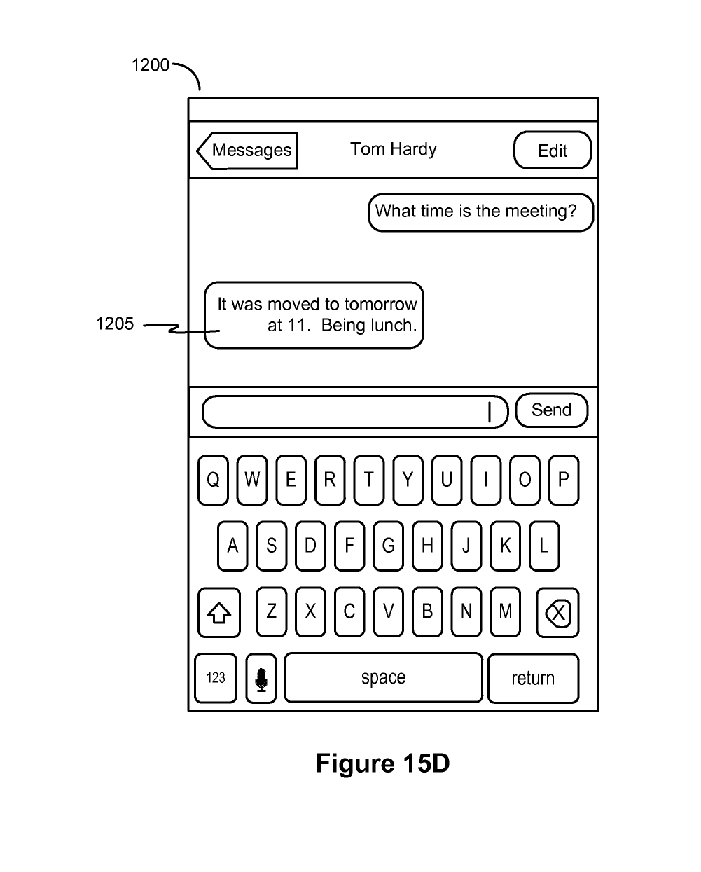

As described above, a replacement character string in a message sent to a recipient is visually distinguished within the message from one or more other character strings in the message. In some embodiments, the electronic device displaying the user interface 1200 ceases to visually distinguish a replacement character string from other strings in response to one or more user inputs at the user interface 1200. FIGS. 15A-D illustrate example inputs causing the device to cease visually distinguishing a replacement string from other strings in the message 1205. In FIG. 15A, the electronic device receives a user input to start composing a new electronic message. For example, the device detects a user input 1502 in a text entry box 1504 and interprets the user input 1502 as a command to start composing a new message. In response to receiving the input to start composing a new message, the device ceases to visually distinguish the replacement character strings in the message 1205 from other character strings in the transcript 1202, as shown in FIG. 15B. For example, the replacement character strings are displayed in the same font, font size, font style, color, and highlighting as the other character strings in the message 1205.

Another example input to cease visually distinguishing the replacement character strings in the message 1205 is illustrated in FIG. 15C. In some embodiments, as shown in FIG. 15C, the user interface 1200 provides an element 1510 to accept the replacement character strings 1206 as corrections to the message 1205. When the device receives a user input corresponding to the accept changes element 1510, such as a touch input 1512 at the location of the element 1510, the device ceases to visually distinguish the replacement character strings in the message 1205 from other character strings in the message, as shown in FIG. 15D.

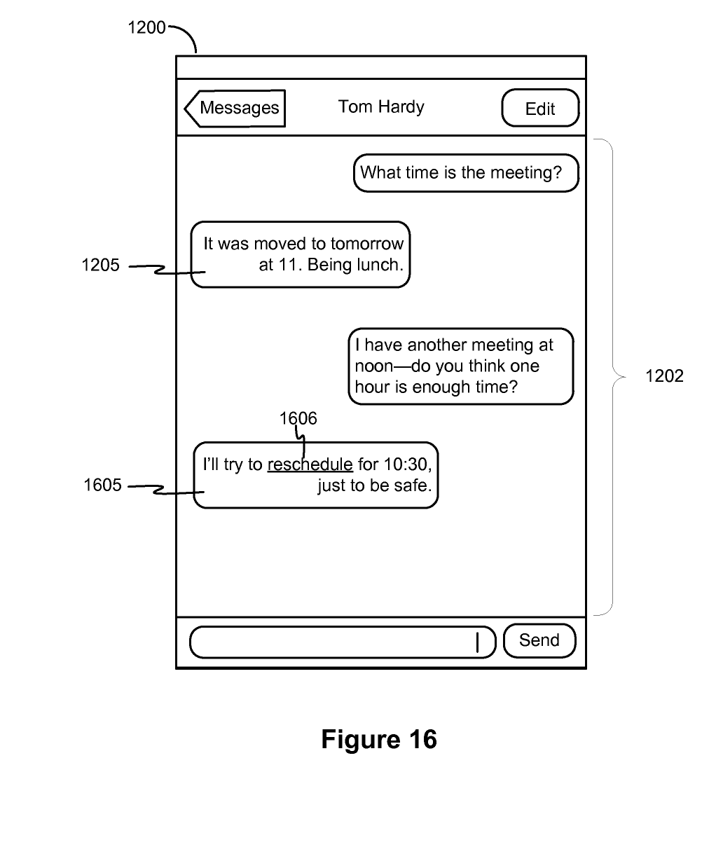

In some embodiments, replacement character strings are distinguished from other character strings in the transcript 1202 for a most recent message but are not distinguished for older messages in the transcript 1202. For example, a user may be more interested in replacement character strings in a most recent message than replacement character strings in older messages. To avoid cluttering the transcript 1202 by visually distinguishing replacement character strings in older messages, the electronic device may remove visual distinction from the older messages (e.g., displaying the replacement character strings in the same font, font size, font style, font color, and highlighting as other character strings in the older messages). FIG. 16 illustrates the transcript 1202 including a message 1605 sent to the user of the interface 1200 after the message 1205 was received. As shown in FIG. 16, a replacement string 1606 is visually distinguished in the message 1605 from other strings in the transcript 1202. Replacement strings in the message 1205 are not distinguished from other strings in the transcript 1202.

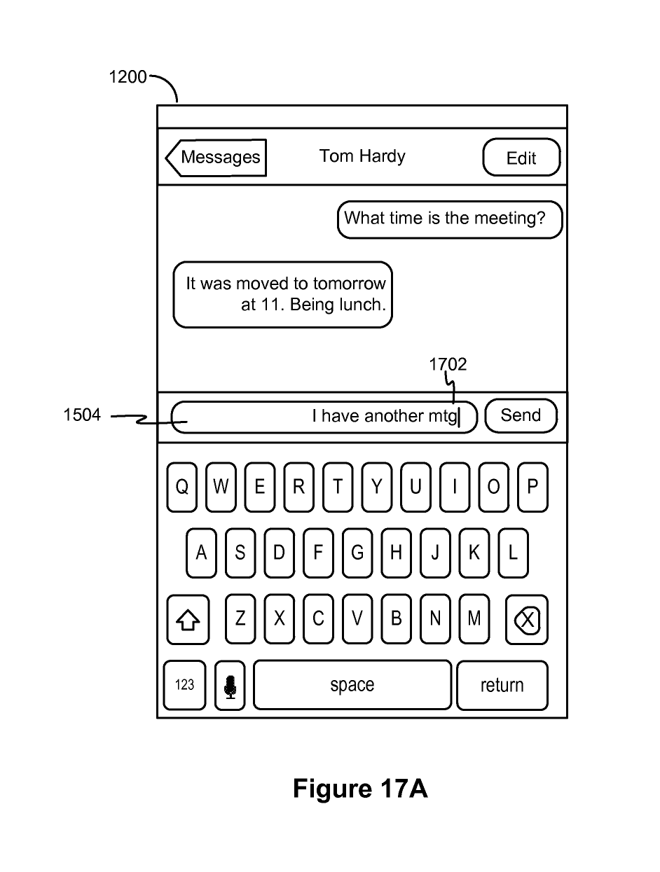

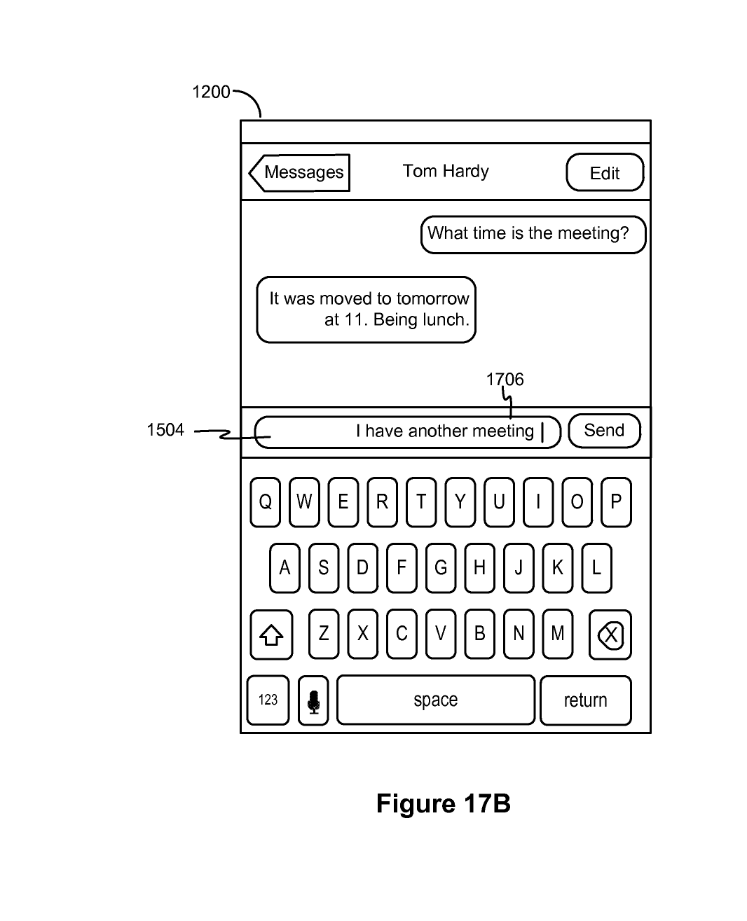

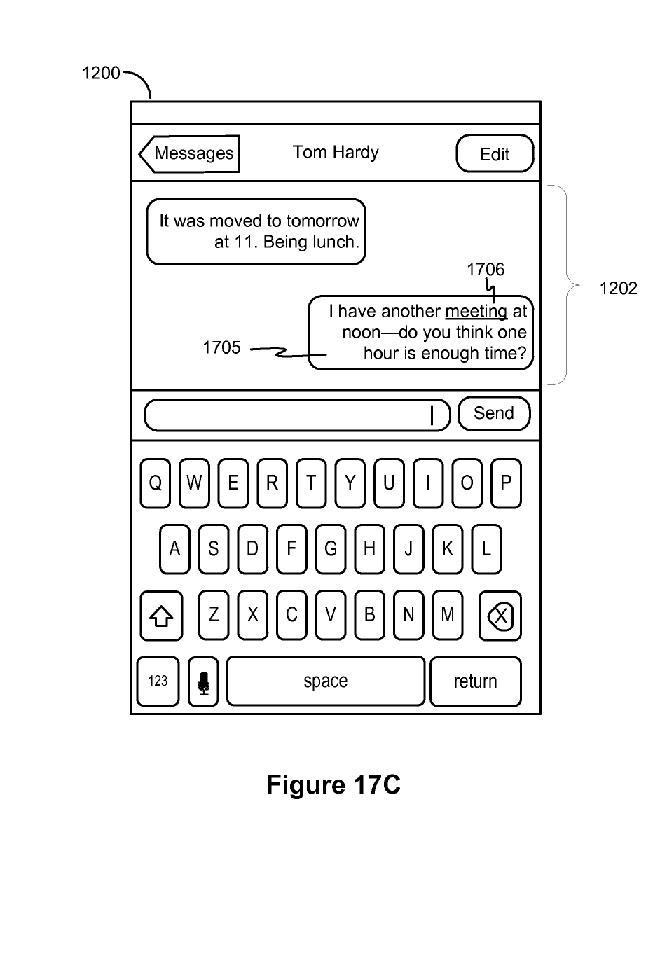

In some embodiments, the user interface 1200 also enables a user to compose and send electronic messages. For example, the user of the interface 1200 can compose a response to the electronic message 1205. FIGS. 17A-C illustrate an example of an electronic message composed at the user interface 1200. Embodiments of the user interface 1200 for composing electronic messages may be similar to embodiments of the user interface 500 described with respect to FIGS. 5A-11. For example, the user interface 1200 includes a text entry box 1504 displaying a draft electronic message as the user composes the message.

As shown in FIG. 17A, the user has entered a portion of an electronic message into the text entry box 1504. The draft electronic message includes a first character string 1702 (here, “mtg”) entered by the user. After the user enters a space after the first character string 1702 to complete the first character string 1702, the electronic device modifies the draft response by replacing the first character string 1702 with a second character string 1706 (here, “meeting”), as shown in FIG. 17B. For example, the device replaces the first character string 1702 with a word that is a correction of the first character string 1702. The device may select the second character string 1706 without explicit input from the user, or the user may select or confirm the second character string 1706 from a set of one or more replacement character strings proposed by the electronic device.

The electronic device sends the modified electronic message (which may include additional character strings entered after the second character string 1706), and, as shown in FIG. 17C, displays the sent message 1705 in the transcript 1202. The second character string 1706, which replaced the first character string 1702 shown in FIG. 17A, is visually distinguished in the transcript 1202 from one or more other strings. For example, the second character string 1706 is underlined in FIG. 17C, while other strings in the message 1705 are not underlined. The second character string 1706 may alternatively be displayed in a different font, a different font style, a different font size, a different color, or a different highlighting than one or more other strings in the transcript 1202. Processes and user interfaces for sending the modified electronic message and displaying the message with the second character string visually distinguished from other character strings in the transcript 1202 may be similar to the processes and user interfaces described above with respect to FIGS. 5A-11.

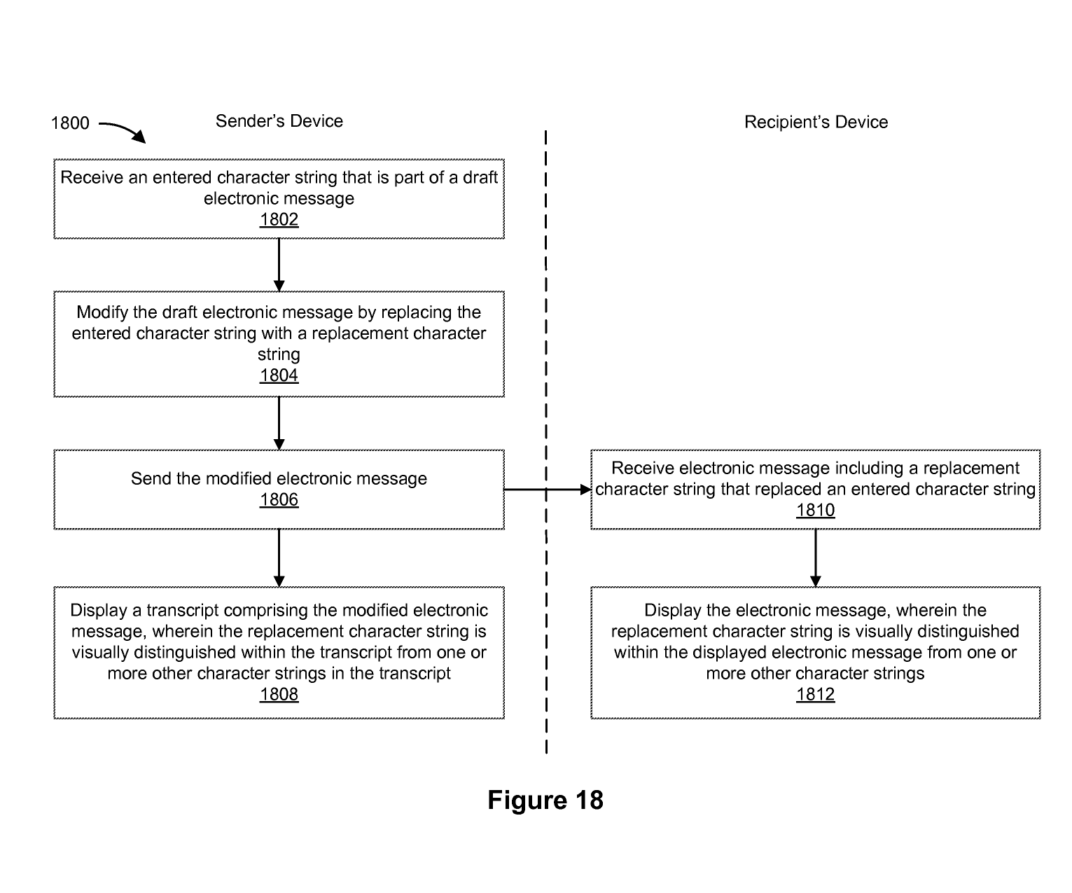

FIG. 18 is a flowchart illustrating a method 1800 for sending electronic messages including replacement character strings, according to some embodiments. The method 1800 is performed at an electronic device of a message sender and an electronic device of a message recipient. The portion of FIG. 18 to the left of the dashed line is performed at a sender's device, while the portion of FIG. 18 to the right of the dashed line is performed at a recipient's device. Example electronic devices performing the method 1800 are portable multifunction device 100 shown in FIG. 1A or device 300 shown in FIG. 3. Other embodiments of the method 1800 may include fewer, additional, or different steps than those shown in FIG. 18, and the steps may be performed in different orders.

An electronic device used by a sender of an electronic message receives 1802 an entered character string (e.g., entered character string 504 in FIG. 5A). The entered character string is part of a draft electronic message, such as an instant message, a text message, or an email.

The sender's electronic device modifies 1804 the draft electronic message by replacing the entered character string with a replacement character string (e.g., replacement character string 506A in FIG. 5B). In some embodiments, the electronic device selects the replacement character string as a correction of the entered character string based on a similarity of the replacement string to the entered string, pre-defined text expansions, or other criteria. The electronic device may automatically replace the entered character string with the replacement character string without explicit input from the user. Alternatively, the user may select or confirm the replacement character string as a replacement for the entered character string.

The sender's electronic device sends 1806 the modified electronic message to one or more recipients. The message may be sent with replacement information including the entered character string or candidate replacement character strings and an indication that the replacement character string replaced the entered character string. The replacement information enables a device of a recipient of the message to display the modified electronic message with the replacement character string visually distinguished within the message from one or more other character strings.

A transcript (e.g., transcript 502 in FIG. 6A) comprising the modified electronic message (e.g., message 605 in FIG. 6A) is displayed 1808 by the sender's electronic device. The replacement character string is visually distinguished within the transcript from one or more other character strings in the transcript. For example, the replacement character string is visually distinguished from character strings adjacent to the replacement string in the transcript. To visually distinguish the replacement character string from other strings, the sender's electronic device may display the replacement character string in a different font, a different font style, a different font size, a different font color, or a different highlighting than the other strings.

An electronic device used by a recipient of the electronic message receives 1810 the electronic message from the sender's electronic device. The recipient's electronic device displays 1812 the electronic message (e.g., message 1205 in FIG. 12). When displayed by the recipient's device, the replacement character string (e.g., replacement character strings 1206A and 1206B in FIG. 12) is visually distinguished in the displayed message from one or more other character strings in the message, such as character strings adjacent to the replacement string in the message. To visually distinguish the replacement character string from other strings, the recipient's electronic device may display the replacement character string in a different font, a different font style, a different font size, a different color, or a different highlighting than the other strings.

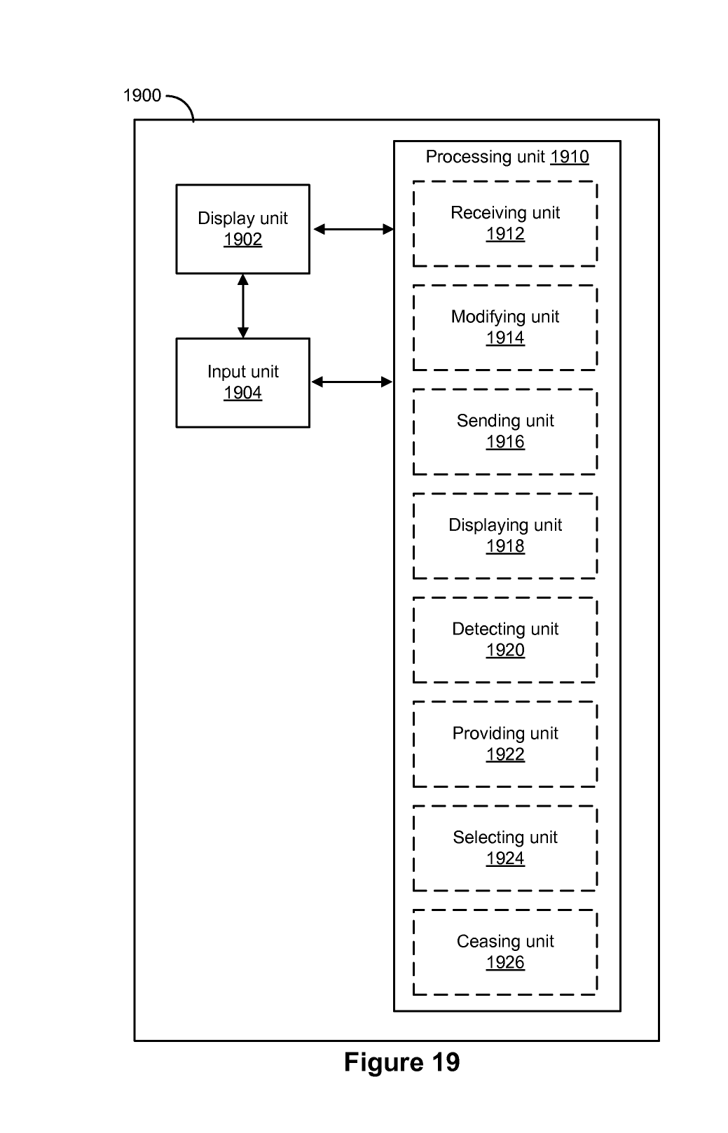

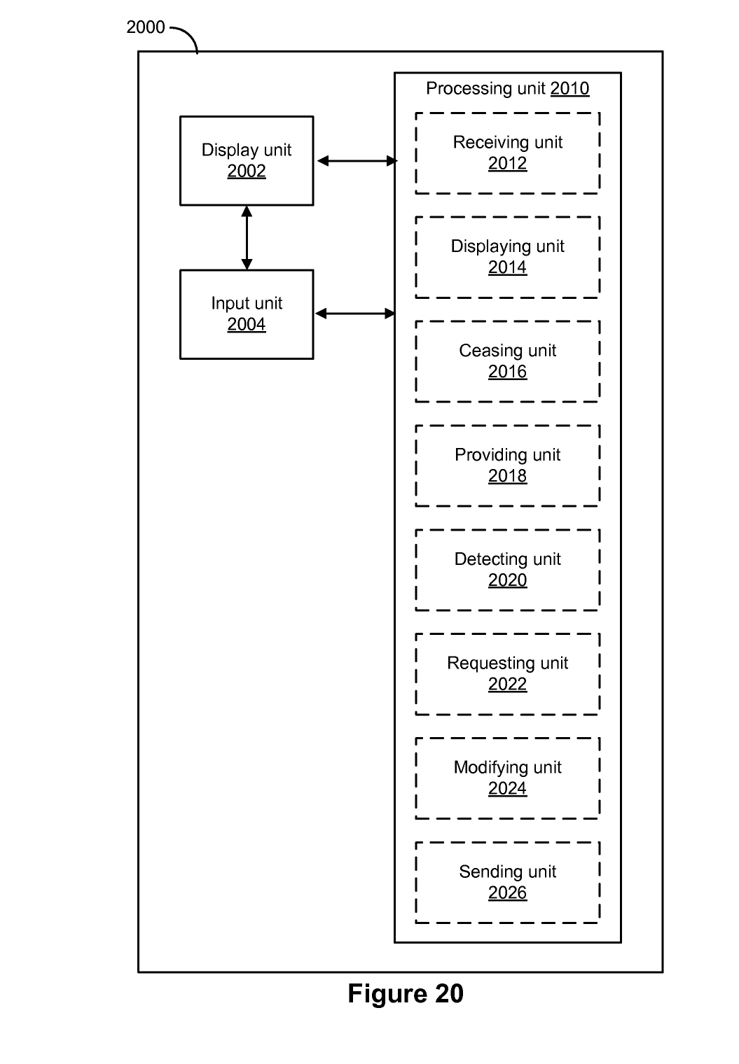

The operations described with respect to FIG. 18 are optionally implemented by components depicted in FIGS. 19 and 20. In accordance with some embodiments, FIG. 19 shows a functional block diagram of an electronic device 1900 configured in accordance with the principles of various described embodiments. The functional blocks of the device are, optionally, implemented by hardware, software, or a combination of hardware and software to carry out the principles of various described embodiments. It is understood by persons of skill in the art that the functional blocks described in FIG. 19 are, optionally, combined or separated into sub-blocks to implement the principles of the various described embodiments. Therefore, the description herein optionally supports any possible combination or separation or further definition of the functional blocks described herein.

As shown in FIG. 19, an electronic device 1900 includes a display unit 1902 adapted to display a user interface for a sender to compose and view an electronic message, an input unit 1904 adapted to receive user inputs, and a processing unit 1910 coupled to the display unit 1902 and the input unit 1904. In some embodiments, the processing unit 1910 includes a receiving unit 1912, a modifying unit 1914, a sending unit 1916, a displaying unit 1918, a detecting unit 1920, a providing unit 1922, a selecting unit 1924, and a ceasing unit 1926.

The processing unit 1910 is configured to receive an entered character string (e.g., with the receiving unit 1912), wherein the entered character string is part of a draft electronic message. The processing unit 1910 is also configured to modify (e.g., with the modifying unit 1914) the draft electronic message by replacing the entered character string with a replacement character string and send (e.g., with the sending unit 1916) the modified electronic message. The processing unit 1910 is further configured to display (e.g., with the displaying unit 1918) a transcript comprising the modified electronic message, wherein the replacement character string is visually distinguished within the transcript from one or more other character strings in the transcript.

In some embodiments, the processing unit 1910 modifies (e.g., with the modifying unit 1914) the draft electronic message automatically without receiving explicit user input requesting modification of the message.

In some embodiments, the processing unit 1910 displays (e.g., with the displaying unit 1918) the replacement character string in one or more of a different font, a different font size, a different font style, a different font color, and a different highlighting than the one or more other character strings in the transcript.

In some embodiments, the processing unit 1910 is also configured to detect (e.g., with the detecting unit 1920) an input that corresponds to a location of the replacement character string displayed within the transcript. Responsive to detecting the input, the processing unit 1910 is configured to display (e.g., with the displaying unit 1918) the entered character string concurrently with the transcript.

In some embodiments, the processing unit 1910 is also configured to, prior to sending the modified electronic message and after receiving the entered character string, receive (e.g., with the receiving unit 1912) another entered character string, wherein the other entered character string is part of the draft electronic message, and modify (e.g., with the modifying unit 1914) the draft electronic message by replacing the other entered character string with another replacement character string. The other replacement character string is visually distinguished within the transcript from one or more other character strings in the transcript. In some embodiments, the processing unit 1910 is configured to display (e.g., with the displaying unit 1918) the entered character string replaced by the replacement character string while displaying the other replacement character string.

In some embodiments, the processing unit 1910 is also configured to, prior to sending the modified electronic message and after receiving the entered character string, receive (e.g., with the receiving unit 1912) another entered character string, wherein the other entered character string is part of the draft electronic message, and modify (e.g., with the modifying unit 1914) the draft electronic message by replacing the other entered character string with another replacement character string. The other replacement character string is visually distinguished within the transcript from one or more other character strings in the transcript. In some embodiments, the processing unit 1910 is configured to display (e.g., with the displaying unit 1918) the entered character string replaced by the replacement character string while displaying the other entered character string replaced by the other replacement character string.

In some embodiments, the processing unit 1910 is also configured to, while displaying the transcript and the entered character string, provide (e.g., with the providing unit 1922) an option to send a second electronic message, the second electronic message including identical text as the previously-sent modified electronic message except having the replacement character string replaced by the entered character string. The processing unit 1910 is also configured to detect (e.g., with the detecting unit 1920) a selection of the option to send the second electronic message. Responsive to detecting the selection of the option to send the second electronic message, the processing unit 1910 is configured to send (e.g., with the sending unit 1916) the second electronic message.

In some embodiments, the processing unit 1910 is also configured to, while displaying the transcript and the entered character string, provide (e.g., with the providing unit 1922), an option to send a second electronic message, the second electronic message indicating the replacement character string should have been the entered character string. The processing unit 1910 is also configured to detect (e.g., with the detecting unit 1920) a selection of the option to send the second electronic message. Responsive to detecting the selection of the option to send the second electronic message, the processing unit 1910 is configured to send (e.g., with the sending unit 1916) the second electronic message.

In some embodiments, the processing unit 1910 is also configured to, prior to sending the modified electronic message, select (e.g., with the selecting unit 1916) the replacement character string from a set of candidate replacement character strings. The processing unit 1910 is also configured to detect (e.g., with the detecting unit 1920) an input that corresponds to a location of the replacement character string displayed within the transcript. Responsive to detecting the input, the processing unit 1910 is configured to display (e.g., with the displaying unit 1918) concurrently with the transcript one or more candidate replacement character strings from the set of candidate replacement character strings, the one or more displayed candidate replacement character strings comprising at least one character string that is neither the entered character string nor the replacement character string.

In some embodiments, the processing unit 1910 is also configured to, while displaying the transcript and the one or more candidate replacement character strings, provide (e.g., with the providing unit 1922) an option to send a second electronic message, the second electronic message including identical text as the previously-sent modified electronic message except having the replacement character string replaced by the a selected candidate replacement character string. The processing unit 1910 is also configured to detect (e.g., with the detecting unit 1920) a selection of the option to send the second electronic message. Responsive to detecting the selection of the option to send the second electronic message, the processing unit 1910 is configured to send (e.g., with the sending unit 1916) the second electronic message.

In some embodiments, the processing unit 1910 is also configured to, while displaying the transcript and the one or more candidate replacement character strings, provide (e.g., with the providing unit 1922) an option to send a second electronic message, the second electronic message indicating the replacement character string should have been a selected candidate replacement character string. The processing unit 1910 is also configured to detect (e.g., with the detecting unit 1920) a selection of the option to send the second electronic message. Responsive to detecting the selection of the option to send the second electronic message, the processing unit 1910 is configured to send (e.g., with the sending unit 1916) the second electronic message.

In some embodiments, the processing unit 1910 is also configured to, prior to sending the modified electronic message, display (e.g., with the displaying unit 1918) the draft electronic message. Responsive to modifying the draft electronic message, the processing unit 1910 is configured to display (e.g., with the displaying unit 1918) the modified electronic message, wherein the replacement character string is visually distinguished in the displayed modified electronic message from one or more other character strings in the displayed modified electronic message.

In some embodiments, the processing unit 1910 is also configured to, prior to sending the modified electronic message, detect (e.g., with the detecting unit 1920) a precursor to a send message input. Responsive to detecting the precursor to the send message input, the processing unit 1910 is configured to display (e.g., with the displaying unit 1918) the modified electronic message, wherein the replacement character string is visually distinguished in the displayed modified electronic message from one or more other character strings in the displayed modified electronic message.

In some embodiments, the processing unit 1910 is also configured to detect (e.g., with the detecting unit 1920) a subsequent input following detecting the precursor to the send message input. In response to detecting the subsequent input, the processing unit 1910 is also configured to, in accordance with a determination that the subsequent input includes a send message input, send (e.g., with the sending unit 1916) the message, and, in accordance with a determination that the subsequent input includes a send cancel input, forgo sending the message.

In some embodiments, the processing unit 1910 is also configured to receive (e.g., with the receiving unit 1912) a command to display a portion of the transcript without visually distinguishing the replacement character string from the one or more other character strings in the transcript. Responsive to receiving the command, the processing unit 1910 is also configured to display (e.g., with the displaying unit 1918) the portion of the transcript without visually distinguishing the replacement character string from the one or more other character strings in the transcript.

In some embodiments, the processing unit 1910 is also configured to, while displaying the transcript comprising the modified electronic message and visually distinguishing the replacement character string from the one or more other character strings in the transcript, receive (e.g., with the receiving unit 1912) a second entered character string, the second entered character string part of a second draft electronic message. The processing unit 1910 is also configured to modify (e.g., with the modifying unit 1914) the second draft electronic message by replacing the second entered character string with a second replacement character string. The processing unit 1910 is further configured to send (e.g., with the sending unit 1916) the second modified electronic message, and display (e.g., with the displaying unit 1918) the transcript with the second modified electronic message, wherein the second replacement character string is visually distinguished within the transcript from one or more other character strings in the transcript. The processing unit 1910 is also configured to cease (e.g., with the ceasing unit 1926) to visually distinguish the replacement character string in the modified electronic message.

In some embodiments, the processing unit 1910 is also configured to send (e.g., with the sending unit 1916) replacement information including the entered character string and an indication that the replacement character string replaced the entered character string, wherein the replacement information enables a device of a recipient of the modified electronic message to display the modified electronic message with the replacement character string visually distinguished from one or more other character strings in the electronic message.

In some embodiments, the replacement character string is an automatic correction of the replacement character string, and the modified electronic message further comprises another replacement character string that is a user-selected correction of another entered character string. The processing unit 1910 is also configured to display (e.g., with the displaying unit 1918) the modified electronic message with the replacement character string and the other replacement character string, wherein the replacement character string is visually distinguished from the other replacement character string in the transcript.

In some embodiments, the replacement character string is an automatic correction of the entered character string, and the modified electronic message further comprises another replacement character string that is a user-selected correction of another entered character string. The processing unit 1910 is further configured to display (e.g., with the displaying unit 1918) the modified electronic message with the replacement character string and the other replacement character string, wherein the replacement character string and the other replacement character string are visually distinguished from the one or more other character strings in the transcript.

In accordance with some embodiments, FIG. 20 shows a functional block diagram of an electronic device 2000 configured in accordance with the principles of various described embodiments. The functional blocks of the device are, optionally, implemented by hardware, software, or a combination of hardware and software to carry out the principles of various described embodiments. It is understood by persons of skill in the art that the functional blocks described in FIG. 20 are, optionally, combined or separated into sub-blocks to implement the principles of the various described embodiments. Therefore, the description herein optionally supports any possible combination or separation or further definition of the functional blocks described herein.

As shown in FIG. 20, an electronic device 2000 includes a display unit 2002 adapted to display a user interface for a user to view an electronic message, an input unit 2004 adapted to receive user inputs, and a processing unit 2010 coupled to the display unit 2002 and the input unit 2004. In some embodiments, the processing unit 2010 includes a receiving unit 2012, a displaying unit 2014, a ceasing unit 2016, a providing unit 2018, a detecting unit 2020, a requesting unit 2022, a modifying unit 2024, and a sending unit 2026.

The processing unit 2010 is configured to receive (e.g., with the receiving unit 2012) an electronic message, wherein the electronic message includes a replacement character string that replaced an entered character string prior to the electronic message being sent. The processing unit 2010 is also configured to display (e.g., with the displaying unit) the electronic message, wherein the replacement character string is visually distinguished within the displayed electronic message from one or more other character strings in the electronic message.

In some embodiments, the processing unit 2010 is also configured to display (e.g., with the displaying unit 2014) a transcript comprising the electronic message.

In some embodiments, the processing unit 2010 is also configured to, while displaying the electronic message and visually distinguishing the replacement character string from the one or more other character strings in the electronic message, receive (e.g., with the receiving unit 2012) a second electronic message, wherein the second electronic message includes a second replacement character string that replaced a second entered character string prior to the second electronic message being sent. The processing unit 2010 is also configured to display (e.g., with the displaying unit 2014) the second electronic message, wherein the second replacement character string is visually distinguished within the second electronic message from one or more other character strings in the second electronic message. The processing unit 2010 is also configured to cease (e.g., with the ceasing unit 2016) to visually distinguish the replacement character string in the electronic message.

In some embodiments, the replacement character string is an accepted auto-correction of the entered character string.

In some embodiments, the processing unit 2010 is also configured to display (e.g., with the displaying unit 2010) the replacement character string in one of a different font, a different font size, a different font style, a different font color, and a different highlighting than the one or more other character strings in the electronic message.

In some embodiments, the processing unit 2010 is also configured to provide (e.g., with the providing unit 2018) an option to request a clarification of the replacement character string. The processing unit 2010 is also configured to detect (e.g., with the detecting unit 2020) a selection of the option to request the clarification. Responsive to detecting the selection of the option to request the clarification, the processing unit 2010 is configured to request (e.g., with the requesting unit 2022) the clarification.

In some embodiments, the request for clarification includes an indication of the replacement character string.

In some embodiments, the processing unit 2010 is also configured to detect (e.g., with the detecting unit 2020) an input that corresponds to a location of the displayed replacement character string. Responsive to detecting the input, the processing unit 2010 is configured to display (e.g., with the displaying unit 2014) the entered character string.

In some embodiments, the processing unit 2010 is also configured to display (e.g., with the displaying unit 2014) the entered character string to a recipient of the electronic message without altering a view of the electronic message on a device of a sender of the electronic message.

In some embodiments, the electronic message is sent to a plurality of recipients, and the processing unit 2010 is also configured to display (e.g., with the displaying unit 2014) the entered character string to one of the recipients without altering a view of the electronic message on devices of other recipients in the plurality of recipients.

In some embodiments, the electronic message further includes another replacement character string that replaced another entered character string prior to the electronic message being sent, and the processing unit 2010 is also configured to display (e.g., with the displaying unit 2014) the entered character string replaced by the replacement character string while displaying the other replacement character string.

In some embodiments, the electronic message further includes another replacement character string that replaced another entered character string prior to the electronic message being sent, and the processing unit 2010 is also configured to display (e.g., with the displaying unit 2014) the entered character string replaced by the replacement character string while displaying the other entered character string replaced by the other replacement character string.

In some embodiments, after displaying the entered character string for a period of time, the processing unit 2010 is also configured to cease (e.g., with the ceasing unit 2016) displaying the entered character string.

In some embodiments, the processing unit 2010 is also configured to receive (e.g., with the receiving unit 2012) a command to cease visually distinguishing the replacement character string from the one or more other character strings in the electronic message. Responsive to receiving the command, the processing unit 2010 is configured to display (e.g., with the displaying unit 2014) the electronic message without visually distinguishing the replacement character string from the one or more other character string in the electronic message.

In some embodiments, the replacement character string was selected from a set of candidate replacement character strings, and the processing unit 2010 is also configured to detect (e.g., with the detecting unit 2020) an input that corresponds to a location of the replacement character string displayed within the electronic message. The processing unit 2010 is also configured to, responsive to detecting the input, display (e.g., with the displaying unit 2014) one or more candidate replacement character strings, the one or more displayed candidate replacement character strings comprising at least one character string that is neither the replacement character string nor the entered character string.

In some embodiments, the processing unit 2010 is also configured to receive (e.g., with the receiving unit 2012) a draft response to the electronic message, the draft response comprising a first character string. The processing unit 2010 is also configured to modify (e.g., with the modifying unit 2024) the draft response by replacing the first character string with a second character string. The processing unit 2010 is also configured to send (e.g., with the sending unit 2026) the modified response, and display (e.g., with the displaying unit 2014) a transcript comprising the modified response, wherein the second character string is visually distinguished within the transcript from one or more other character strings in the transcript.

The operations in the information processing methods described above are, optionally, implemented by running one or more functional modules in information processing apparatus such as general purpose processors (e.g., as described above with respect to FIGS. 1A and 3) or application specific chips.

The operations described above with reference to FIG. 18 are, optionally, implemented by components depicted in FIGS. 1A-B, FIG. 19, or FIG. 20. For example, receiving operations 1802 and 1810, modifying operation 1804, sending operation 1806, and displaying operations 1808 and 1812 are, optionally, implemented by event sorter 170, event recognizer 180, and event handler 190. Event monitor 171 in event sorter 170 detects a contact on touch-sensitive display 112, and event dispatcher module 174 delivers the event information to the application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event hander 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
receiving an entered character string, wherein the entered character string is part of a draft electronic message;
modifying the draft electronic message by replacing the entered character string with a replacement character string;
sending the modified electronic message; and
displaying a transcript comprising the modified electronic message, wherein the replacement character string is visually distinguished within the transcript from one or more other character strings in the transcript.

2. The method of claim 1, wherein the draft electronic message is modified automatically without receiving explicit user input requesting modification of the message.

3. The method of claim 1, wherein displaying the transcript comprising the modified electronic message comprises displaying the replacement character string in one or more of a different font, a different font size, a different font style, a different font color, and a different highlighting than the one or more other character strings in the transcript.

4. The method of claim 1, further comprising:
detecting an input that corresponds to a location of the replacement character string displayed within the transcript; and
responsive to detecting the input, displaying the entered character string concurrently with the transcript.

5. The method of claim 4, further comprising:
prior to sending the modified electronic message:
after receiving the entered character string, receiving an other entered character string, wherein the other entered character string is part of the draft electronic message; and
modifying the draft electronic message by replacing the other entered character string with an other replacement character string;
wherein the other replacement character string is visually distinguished within the transcript from one or more other character strings in the transcript; and
wherein displaying the entered character string concurrently with the transcript comprises displaying the entered character string replaced by the replacement character string while displaying the other replacement character string.

6. The method of claim 4, further comprising:
prior to sending the modified electronic message:
after receiving the entered character string, receiving an other entered character string, wherein the other entered character string is part of the draft electronic message; and
modifying the draft electronic message by replacing the other entered character string with an other replacement character string;
wherein the other replacement character string is visually distinguished within the transcript from one or more other character strings in the transcript; and
wherein displaying the entered character string concurrently with the transcript comprises displaying the entered character string replaced by the replacement character string while displaying the other entered character string replaced by the other replacement character string.

7. The method of claim 4, further comprising:
while displaying the transcript and the entered character string, providing an option to send a second electronic message, the second electronic message including identical text as the previously-sent modified electronic message except having the replacement character string replaced by the entered character string;
detecting a selection of the option to send the second electronic message; and
responsive to detecting the selection of the option to send the second electronic message, sending the second electronic message.

8. The method of claim 4, further comprising:
while displaying the transcript and the entered character string, providing an option to send a second electronic message, the second electronic message indicating the replacement character string should have been the entered character string;
detecting a selection of the option to send the second electronic message; and
responsive to detecting the selection of the option to send the second electronic message, sending the second electronic message.

9. The method of claim 1, further comprising:
prior to sending the modified electronic message, selecting the replacement character string from a set of candidate replacement character strings;
detecting an input that corresponds to a location of the replacement character string displayed within the transcript; and
responsive to detecting the input, displaying concurrently with the transcript one or more candidate replacement character strings from the set of candidate replacement character strings, the one or more displayed candidate replacement character strings comprising at least one character string that is neither the entered character string nor the replacement character string.

10. The method of claim 9, further comprising:
while displaying the transcript and the one or more candidate replacement character strings, providing an option to send a second electronic message, the second electronic message including identical text as the previously-sent modified electronic message except having the replacement character string replaced by a selected candidate replacement character string;
detecting a selection of the option to send the second electronic message; and
responsive to detecting the selection of the option to send the second electronic message, sending the second electronic message.

11. The method of claim 9, further comprising:
while displaying the transcript and the one or more candidate replacement character strings, providing an option to send a second electronic message, the second electronic message indicating the replacement character string should have been a selected candidate replacement character string;
detecting a selection of the option to send the second electronic message; and
responsive to detecting the selection of the option to send the second electronic message, sending the second electronic message.

12. The method of claim 1, further comprising:
prior to sending the modified electronic message:
displaying the draft electronic message; and
responsive to modifying the draft electronic message, displaying the modified electronic message, wherein the replacement character string is visually distinguished in the displayed modified electronic message from one or more other character strings in the displayed modified electronic message.

13. The method of claim 1, further comprising:
prior to sending the modified electronic message:
detecting a precursor to a send message input; and
responsive to detecting the precursor to the send message input, displaying the modified electronic message, wherein the replacement character string is visually distinguished in the displayed modified electronic message from one or more other character strings in the displayed modified electronic message.

14. The method of claim 13, further comprising:
detecting a subsequent input following detecting the precursor to the send message input; and
in response to detecting the subsequent input:
in accordance with a determination that the subsequent input includes a send message input, sending the message; and
in accordance with a determination that the subsequent input includes a send cancel input, forgoing sending the message.

15. The method of claim 1, further comprising:
receiving a command to display a portion of the transcript without visually distinguishing the replacement character string from the one or more other character strings in the transcript; and
responsive to receiving the command, displaying the portion of the transcript without visually distinguishing the replacement character string from the one or more other character strings in the transcript.

16. The method of claim 1, further comprising:
while displaying the transcript comprising the modified electronic message and visually distinguishing the replacement character string from the one or more other character strings in the transcript:
receiving a second entered character string, the second entered character string part of a second draft electronic message;
modifying the second draft electronic message by replacing the second entered character string with a second replacement character string;
sending the second modified electronic message;
displaying the transcript with the second modified electronic message, wherein the second replacement character string is visually distinguished within the transcript from one or more other character strings in the transcript; and
ceasing to visually distinguish the replacement character string in the modified electronic message.

17. The method of claim 1, wherein sending the modified electronic message includes sending replacement information including the entered character string and an indication that the replacement character string replaced the entered character string, wherein the replacement information enables a device of a recipient of the modified electronic message to display the modified electronic message with the replacement character string visually distinguished from one or more other character strings in the electronic message.

18. The method of claim 1, wherein the replacement character string is an automatic correction of the entered character string, and wherein the modified electronic message further comprises an other replacement character string that is a user-selected correction of an other entered character string, and wherein displaying the transcript comprises:
displaying the modified electronic message with replacement character string and the other replacement character string, wherein the replacement character string is visually distinguished from the other replacement character string in the transcript.

19. The method of claim 1, wherein the replacement character string is an automatic correction of the entered character string, and wherein the modified electronic message further comprises an other replacement character string that is a user-selected correction of an other entered character string, and wherein displaying the transcript comprises:
displaying the modified electronic message with the replacement character string and the other replacement character string, wherein the replacement character string and the other replacement character string are visually distinguished from the one or more other character strings in the transcript.

20. A non-transitory computer readable storage medium storing executable code, the code when executed causing a processor to perform steps comprising:
receiving an entered character string, wherein the entered character string is part of a draft electronic message;
modifying the draft electronic message by replacing the entered character string with a replacement character string;
sending the modified electronic message; and
displaying a transcript comprising the modified electronic message, wherein the replacement character string is visually distinguished within the transcript from one or more other character strings in the transcript.

20. A non-transitory computer readable storage medium storing executable code, the code when executed causing a processor to perform steps comprising:
receiving an entered character string, wherein the entered character string is part of a draft electronic message;
modifying the draft electronic message by replacing the entered character string with a replacement character string;
sending the modified electronic message; and
displaying a transcript comprising the modified electronic message, wherein the replacement character string is visually distinguished within the transcript from one or more other character strings in the transcript.

21. A system comprising:
a non-transitory computer-readable storage medium including instructions to:
receiving an entered character string, wherein the entered character string is part of a draft electronic message;
modifying the draft electronic message by replacing the entered character string with a replacement character string;
sending the modified electronic message; and
displaying a transcript comprising the modified electronic message, wherein the replacement character string is visually distinguished within the transcript from one or more other character strings in the transcript; and
a computer processor for executing the instructions.
